(19) United States
(12) Patent Application Publication
(10) Pub. No.: US 2026/0321155 A1
(43) Pub. Date: Oct. 15, 2026

(54) Method and System for Improving Musical Instrument Performance

(71) Applicant: Sharp and Flat, Inc., Wilmington, DE (US)

(72) Inventors: James Lenger, Holland, MI (US); Naresh Punjabi, Coral Gables, FL (US)

(21) Appl. No.: 19/644,112

(22) Filed: Apr. 10, 2026

Related U.S. Application Data
(60) Provisional application No. 63/787,543, filed on Apr. 11, 2025.

(51) Int. Cl. G09B 15/06; G06F 3/01; G10D 3/00

(52) U.S. Cl. CPC G09B 15/06; G06F 3/014; G10D 3/00

(57) ABSTRACT

A method and system for improving musical instrument performance is disclosed. The system comprises a guide device for positioning at least one of a user's forearm, wrist, or hand in relation to a musical instrument. The guide device comprises at least one strap removably coupled to the musical instrument and at least one securing portion coupled to the at least one strap to accommodate the user's forearm, wrist, or hand. The system further comprises a biometric measurement device configured to monitor movement of the forearm, wrist, or hand of the user, and a device including a graphical user interface configured to provide feedback of the position or movement of the forearm, wrist, or hand of the user from the biometric measurement device.

### CROSS-REFERENCE TO RELATED APPLICATION(S)

This application claims the benefit of U.S. Provisional Application No. 63/787,543, entitled “Method and System for Improving Musical Instrument Performance,” filed on Apr. 11, 2025, the entire contents of which are hereby incorporated.

### TECHNICAL FIELD

This disclosure relates generally to a method and system for improving musical instrument performance with a guide or adaptation device, a biometric measurement device, and a computing device including a graphical user interface.

### BACKGROUND

Novice guitar users and some that have been playing for many years, alike, tend to incorrectly position their strumming/picking hand, wrist, and forearm in relation to the guitar. This improper positioning leads to a number of issues when the guitar users play the guitar, including hitting the guitar itself, starting and stopping their strumming/picking hand and forearm unnecessarily, and playing the guitar rigidly, overall, by keeping their strumming/picking hand and forearm too stiff—among other such issues.

Strumming is a technique in playing a guitar that involves the rhythmic motion of a pick or fingers across most or all the strings. Typically, strumming patterns are characterized by a smooth, pendulum-like arcing that allows for dynamic range in the resulting sound. The strumming motion uses a coordinated downward and upward movement of the wrist, forearm, and/or hand, along with fine motor control. This coordinated movement is useful for producing consistent and fluid strokes.

To maintain a steady rhythm across multiple strings, the strumming motion should incorporate a mixture of (e.g., partial) arm movement with a range of wrist movement and flexibility. Repetitive motions resulting from poor strumming techniques, such as locking the wrist and over-relying on arm movement, can lead to a range of injuries. A relaxed wrist, combined with a stable elbow, allows for a more flexible, fluid, and effective strumming motion, improving both the comfort and quality of sound produced.

To support learners in developing proper techniques, adaptations to the guitar, along with monitoring how those adaptations effect the user's strumming, can be impactful.

Moreover, people with neurological conditions, such as those with Parkinson's disease (PD) or other disorders impacting motor control, often struggle with executing smooth, controlled movements due to factors such as tremors, rigidity, and bradykinesia. These motor symptoms, hallmark features of PD, can impact fine motor tasks, including playing musical instruments like the guitar. The movement limitations experienced by individuals with neurological conditions or motor control impairments, such as PD, can result in improper strumming mechanics.

Accordingly, the present disclosure relates to providing a musical instrument user with a guide device or an adaptation device for a musical instrument that facilitates positioning a guitar user's strumming/picking forearm and/or hand to improve forearm, wrist, and hand dexterity and competence, as well as providing a way to measure and/or monitor a user's wrist, hand, and/or forearm movement when playing the musical instrument and providing the user with (e.g., real-time) feedback based on the collected measurements to facilitate reducing poor technique, provide efficient learning and playing, monitor the user's progress, prevent or minimize injury, aid in therapy, and/or in some instances, identify a neurological condition.

### SUMMARY

In one implementation, a system for improving musical instrument performance is disclosed. The system comprises a guide device for positioning at least one of a user's forearm, wrist, or hand in relation to a musical instrument. The guide device comprises at least one strap removably coupled to the musical instrument and at least one securing portion coupled to the at least one strap to accommodate the user's forearm, wrist, or hand. The system further comprises a biometric measurement device configured to monitor movement of the forearm, wrist, or hand of the user, and a device including a computing device including a graphical user interface configured to provide feedback of the position or movement of the forearm, wrist, or hand of the user from the biometric measurement device.

In another implementation, a method for improving musical instrument performance of a user is disclosed. The method comprises providing a removable guide device for a user to wear while playing a musical instrument, measuring movement dynamics of a forearm, wrist, or hand of the user via a wearable biometric measurement device, and outputting the movement dynamics via a display to provide feedback to the user.

In a further implementation, a tangible, non-transitory computer readable medium comprising instructions that, when executed, cause performance of a set of operations is disclosed. The operations comprise providing a removable guide device for a user to wear while playing a musical instrument, measuring movement dynamics of a forearm, wrist, or hand of the user via a wearable biometric measurement device, and outputting the movement dynamics via a display to provide feedback to the user.

### BRIEF DESCRIPTION OF THE FIGURES

The patent or application file contains at least one drawing executed in color. Copies of this patent or patent application publication with color drawing(s) will be provided by the Office upon receipt and payment of the necessary fee.

The above, as well as additional, features will be better understood through the following illustrative and non-limiting detailed description of example embodiments, with reference to the appended drawings.

FIG. 1 is a simplified block diagram of an example computing device.

FIG. 2A is a removable guide or adaptation device for positioning a user's forearm and hand in relation to a guitar.

FIG. 2B is a removable guide or adaptation device for positioning a user's forearm and hand in relation to a guitar.

FIG. 3A is a removable guide or adaptation device of FIG. 2B, shown coupled to a guitar, according to an example embodiment.

FIG. 3B is the removable guide or adaptation device of FIG. 3A.

FIG. 3C is the removable guide or adaptation device of FIGS. 3A and 3B.

FIG. 4A is an example a musical instrument improvement system comprising a removable guide or adaptation device, a biometric measurement device, and a computing device for positioning, monitoring, and measuring a user's forearm, wrist, and hand in relation to a guitar.

FIG. 4B is the example of the musical instrument improvement system of FIG. 4A, with annotations of example measurements of user's forearm, wrist, or hand, according to an example embodiment.

FIG. 5A is a graph of measurements measured with a biometric measurement device of a user's wrist angle with respect to a user's elbow angle when playing a musical instrument without a guide or adaptation device, and FIG. 5B is a graph of measurements measured with a biometric measurement device of a user's wrist angle with respect to a user's elbow angle when playing a musical instrument with a guide or adaptation device.

FIG. 5C is a graph of measurements of a user with Parkinson's disease measured with a biometric measurement device of a user's wrist angle with respect to a user's elbow angle when playing a musical instrument with a guide or adaptation device and without a guide or adaptation device.

FIG. 6 is a graph of measurements of a user's down strumming of a guitar versus a user's orbit coefficient both with and without adaptation, and a user's up and down strumming of a guitar versus a user's orbit coefficient both with and without adaptation.

FIG. 7 is a table of elbow and wrist angles, in degrees, during a user's down strumming of a guitar across different frequencies with and without the guitar adaptation.

FIG. 8 is another table of elbow and wrist angles, in degrees, during a user's down strumming of a guitar across different frequencies with and without the guitar adaptation.

FIG. 9 is a flow chart of an example method.

FIG. 10 is a table of patient tempo with respect to an orbit coefficient with and without guitar adaptation.

All the figures are schematic, not necessarily to scale, and generally only show parts which are necessary to elucidate example embodiments, wherein other parts may be omitted or merely suggested.

### DETAILED DESCRIPTION

Example embodiments will now be described more fully hereinafter with reference to the accompanying drawings. That which is encompassed by the claims may, however, be embodied in many different forms and should not be construed as limited to the embodiments set forth herein; rather, these embodiments are provided by way of example. Furthermore, like numbers refer to the same or similar elements or components throughout.

The disclosure is directed to providing a musical instrument user with a removable, portable, cost-effective, and convenient guide device (e.g., an adaptation device) for a musical instrument, such as a guitar, that facilitates positioning a guitar user's strumming/picking hand, wrist, and/or forearm to improve dexterity and competence. The disclosure further provides a biometric measurement device to measure and/or monitor the user's wrist, hand, and forearm movement when strumming the musical instrument. The biometric measurement device is in communication with a computing device which may have a display and/or a graphical user interface to provide the user or another person, such as a therapist, with (e.g., real-time) feedback of forearm, wrist, and/or hand movement to facilitate reducing poor technique, provide efficient learning and playing, monitor the user's progress, prevent or minimize injury, aid in therapy, and, in some instances, identify a neurological condition.

In one aspect, the disclosed device counteracts a guitar user's inclination to incorrectly position their forearm and/or hand in relation to the guitar, as well as the problems that arise from such improper positioning and form. These problems include: (i) playing too rigidly (as it is often preferable to keep the strumming/picking hand and forearm looser and more dexterous); (ii) hitting the guitar itself while playing (which can lead to damaging the guitar, the user, or both); (iii) overplaying the guitar in the strumming or picking direction (e.g., going too far on either side of the strings when strumming up and down); and/or (iv) starting and stopping their strumming/picking hand and forearm unnecessarily—among other such issues. Moreover, these issues arise with novice guitar users and those that have been playing for many years, alike.

In one aspect, an (e.g., adaptation or guide) device is disclosed that attaches to a guitar without any modification to the guitar itself and properly guides a user's forearm while the user is playing (e.g., picking and/or strumming) the guitar. In one aspect, the disclosed device holds a user's strumming/picking forearm against the guitar and increases their focus on their wrist with minimal forearm movement, thereby encouraging the guitar user to primarily use just their strumming/picking hand while playing the guitar. By doing so, the disclosed device encourages the user to narrowly focus on controlling and building acumen in their strumming/picking hand, instead of over-relying on the range and movement their forearm provides as well (which can often be counterproductive for playing and control). As detailed further below, the disclosed device also provides a guide for proper forearm direction and placement (and thereby also provides proper strumming/picking hand direction and placement). The disclosed device does so through, among other things, specifically shaped and angled pads attached to the device that guide and restrict the user's forearm while playing the guitar.

In one aspect, the device is made of materials that will not harm the surface, finish or other materials on the guitar itself. These materials include various cotton, leather, vinyl, and/or rubber materials commonly used in the guitar industry (e.g., in guitar straps), as well as other materials that provide support for the adaptation device, but also do not harm the surfaces of the guitar. The device also attaches to the guitar using existing points of connection on the guitar (e.g., one or more strap buttons, and/or other hardware, openings, or controls on the guitar).

Further, although the illustration included in this application primarily illustrate the device in the context of a dreadnought shaped acoustic guitar, the adaptation device can easily be adapted for any number of body shapes and styles of acoustic guitars (e.g., jumbo acoustic guitars, smaller body acoustic guitars, classical acoustic guitars, parlor guitars) made by a number of well-known acoustic guitar manufacturers (e.g., C.F. Martin®, Gibson®, Taylor®), over a number of specific model numbers (e.g., C.F. Martin® D-28, C.F. Martin® OM-28, C.F. Martin® D-28-12, Gibson® J-45, Gibson® J-200, Taylor® 314).

Additionally, the adaptation device can also be adapted for any number of other types, styles, and shapes of other types of musical instruments (e.g., bass, violin, or a cello) or other types of guitars (e.g., solid-body electric guitars, hollow-body electric guitars, electric bass guitars) made by a number of well-known electric and/or bass guitar manufacturers (e.g., Fender®, Gibson®), over a number of specific model numbers (e.g., Fender® Stratocaster®, Fender® Telecaster®, Fender® Jazz Bass®, Fender® Precision Bass®, Gibson® Les Paul®, Gibson® ES-335).

Among other features, the disclosed adaptation device may include one or more straps with one or more perforations to accommodate and/or allow access to one or more features of the guitar (e.g., controls, knobs, switches, and strap buttons on the guitar), as well as other mechanisms of the guitar. The adaptation device is designed to help improve a guitar user's abilities, and may do so in a number of ways.

In one aspect, the disclosure is directed to a removable (e.g., adaptation) device for positioning a user's forearm and hand in relation to a guitar. The device includes a first strap overlying a first portion of the guitar and having attached thereto two pads to help position the user's strumming/picking forearm and hand. The first strap may be made out of various materials (including but not limited to those mentioned above) and a number of similar and/or different materials may be interspersed throughout.

For example, in an example embodiment, the first strap may be provided in the form of cotton, nylon, a combination thereof, and/or other materials. In another aspect, at one end, the first strap may also have a first connector designed to connect to the guitar at a predetermined point. For example, many guitars have a strap button on the bottom-most portion of the body to which the first strap may connect using a precut perforation designed to fit over the strap button. At that connecting end, the first strap may be made of and/or reinforced with one or more additional materials designed to improve the stability and/or longevity of the connection (e.g., a leather portion stitched to the end of the first strap, which contains a precut hole that fits securely over the strap button). In another aspect, in between the first strap and the first connector, one or more elastic portions may also be incorporated to improve the ability of the first strap to stretch and move more freely to fit different instruments and/or guitar shapes and sizes, as well as allow the first strap to not pull unnecessarily against the first connector and strap button, if the first strap is pulled or tightened.

In another aspect, the first strap may have attached thereto one or more pads. Additionally or alternatively, on the portion of the first strap between the two pads, one or more elastic portions may also be incorporated to improve, among other things, the accommodation of different forearm sizes to fit between the two pads, as well as to allow the first strap to not pull unnecessarily against the first connector and strap button (or other portions of the disclosed device), if the guitar user moves their forearm between the two pads (e.g., while playing the guitar). These pads can also be provided in the form of a number of materials and shaped and/or sized depending on the configuration of the device, the user, the guitar, or all three, among other possibilities. For example, to increase comfort and ease of use, these pads may be made out of foam or other compressible, soft materials and/or covered in materials that are easy to clean and/or provide additional comfort, including vinyl, cotton, and/or rubber, among other possibilities. In yet another aspect, these pads may be shaped and/or sized differently to ensure that the user's forearm is best positioned to have the user's wrist and strumming/picking hand properly positioned in relation to the guitar (e.g., directly over the strings, at the proper angle). To do so, in one aspect, one or more of these pads may be designed to promote the user's arm in a specific direction and be contoured to securely fit to the angles and/or dimensions of the user's forearm. Other examples are possible.

In another aspect, these pads may also contain a securing portion that overlies the user's forearm when the forearm is placed between the two pads, thereby further securing the user's forearm between the two pads. This securing portion may be made from a variety of materials (e.g., cotton, nylon, elastic, or some combination thereof) and attached to the two pads using a number of different mechanisms that provide a custom fit for different guitar users (e.g., a nylon strap that attaches to one or both pads using a hook and loop fastener mechanism). In another aspect, the securing portion may not require either or both of these pads to secure the user's forearm. For example, the securing portion may be attached directly to the first strap without any pads and still be used to restrict the motion of the user's forearm and/or hold the user's forearm close to the guitar body. In this configuration, the securing portion may be made from a variety of materials and attached to the first strap using a number of different mechanisms that provide a custom fit for different guitar users (e.g., a nylon strap that attaches on one or both ends to the first strap using a hook and loop fastener mechanism).

In another aspect, the device includes a second strap overlying a second portion of the guitar. The second strap may also be joined to the first strap via the first connector, which is coupled to the guitar at a first point (e.g., a strap button on the bottom most portion of the guitar). The strap itself may be made out of various materials (including those mentioned above) and a number of similar and/or different materials may be interspersed throughout. For example, in one embodiment, like the first strap, the second strap may be made out of cotton, nylon, or a combination of both materials, among other possibilities.

In another aspect, at one end, the second strap may also be joined to the first connector. For example, using the strap button on the bottom-most portion of the body, the first strap and the second strap may be joined using a first connector made of one or more materials that connect to the bottom-most strap button using a precut perforation designed to fit over and secure to the strap button. At the connecting end, the first strap, second strap, or both may be made of one or more additional materials designed to improve the stability and/or longevity of the connection. In another aspect, in between the second strap and the first connector mechanism, one or more elastic portions may also be incorporated to improve, among other things, the ability of the second strap to stretch to fit different guitar shapes and sizes, as well as allow the second strap to not pull unnecessarily against the first connector and strap button, if the second strap is pulled or tightened.

In another aspect, the device includes an adjustment mechanism for tightening and/or loosening the device once the device is placed on the guitar. In one aspect, the adjustment mechanism overlies a third portion of the guitar and is joined to the first strap, the second strap, the first connector, and a second connector. The second connector, like the first connector, may be coupled to the guitar at a certain point.

Unlike the first connector, however, the second connector is designed to connect to the guitar at a predetermined point at, approximately, the portion of the guitar where the guitar neck meets the guitar body. For example, the second connector may be connected to the guitar using a strap button on the heel block of the guitar neck or any other portion of the guitar body approximately where the guitar neck meets the guitar body (e.g., the guitar neck plate or an upper portion of the guitar body), among other possibilities. Furthermore, the second connector may attach to the guitar body and/or guitar neck using something other than a strap button.

For example, the second connector may attach to the guitar using an adjustable lanyard that extends around from the back of the guitar body and attaches to one or more features on the top portion of the guitar (e.g., placed under the fretboard, inside the sound hole of an acoustic guitar and/or other openings on the tops of other types of guitars, onto one or more controls located on the guitar top, etc.). In a further aspect, the second connector may be adjustable and may attach to these features on the top portion of the guitar using materials and/or mechanisms that do not harm or require any modification of the guitar itself (e.g., rubberized and/or plastic hooks akin to those used on some classical guitar straps).

Concerning the adjustment mechanism itself, it can take many forms, depending on the guitar to which it is attached and the desired adjustment features. For example, in one aspect, the adjustment mechanism may be a geared adjustment mechanism that tightens and/or loosens the straps and/or connectors to which it is joined and/or attached. In another example, the adjustment mechanism may be an adjustable buckle and/or pull-strap system (e.g., a ladder lock system, a ratchet strap and cam buckle strap system, a hook and loop fastener mechanism, and/or other strap systems).

In another aspect, the adjustment mechanism may be joined to the first strap, second, first connector, and/or second connector using one or more elastic materials and/or one or more additional materials designed to improve the stability and/or longevity of the connection. Such materials may also improve the ability of the device components to more securely fit different guitar shapes and sizes. These materials may also allow the adjustment mechanism to not pull unnecessarily against the other components of the disclosed device and/or parts of the guitar itself, when the adjustment mechanism is loosened or tightened. Other examples are possible.

Concerning the first connector and second connector, either or both may take various forms. For example, either or both of the connectors may be components that are specifically configured to attach to other components of the device (e.g., perforated elastic ends on one or more of the device straps). In additional or alternative embodiments, either or both of the connectors may be components that resemble other components of the device.

For example, either or both connectors may be made of strap components like the first strap and/or second strap and overlies different portions of the guitar. For example, the device may contain a third strap overlying a third portion of the guitar and joined to the first strap and/or the second strap via the first connector, a fourth strap overlying a fourth portion of the guitar and coupled to the guitar at a second point via the second connector, and/or both, among other possibilities. Further, in between the first connector and/or second connector and whatever each is joined to, there may be one or more elastic portions to improve, among other things, the ability of the device components to stretch to fit different guitar shapes and sizes, as well as allowing the device components to not pull unnecessarily against each other, the guitar's components, and/or both.

In yet another aspect, one or more components of the disclosed device may be made of and/or have attached thereto one or more specific materials to improve the performance of the device when attached to the guitar, while also not harming any surface or component of the guitar. For example, one or more of the device components (e.g., one or more of the device straps) may be made of and/or have attached thereto a variety of low friction materials that allow the device components to move around on and/or interact with the guitar's surface without harming the guitar. These materials may include velour, velvet, synthetic or natural furs, microfibers, and/or cotton, among other possibilities. In other examples, one or more of the device components (e.g., one or more of the device straps) may be made of and/or have attached thereto a variety of high friction materials that allow the device components to avoid moving around on the guitar's surface, while still not requiring any modification to the guitar itself and without harming the guitar. These materials may include rubber and/or rubber materials designed to not harm the guitar's surface (e.g., rubber designed to not adversely react with a nitrocellulose finish, thereby harming the guitar's finish), among other possibilities.

Descriptions of several figures are provided below to further illustrate at least the features described herein.

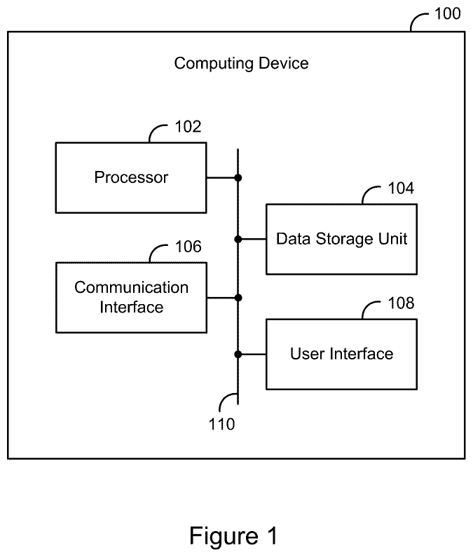

FIG. 1 is a simplified block diagram of an example computing device 100. The computing device 100 can be configured to perform and/or can perform one or more acts and/or functions, such as those described in this disclosure. The computing device 100 can include various components, such as a sensor, a processor 102, a data storage unit 104, a communication interface 106, and/or a user interface 108. Each of these components can be connected to each other via a connection mechanism 110.

In this disclosure, the term “connection mechanism” means a mechanism that facilitates communication between two or more components, devices, systems, or other entities. A connection mechanism can be a relatively simple mechanism, such as a cable or system bus, or a relatively complex mechanism, such as a packet-based communication network (e.g., the Internet). In some instances, a connection mechanism can include a non-tangible medium (e.g., in the case where the connection is wireless).

The sensor can include sensors now known or later developed, including but not limited to accelerometer sensors, a sound detection sensor, a motion sensor, a humidity sensor, a temperature sensor, a proximity sensor (e.g., a Bluetooth sensor and/or communication protocol to determine the proximity of a biometric computing device to one or more portions and/or features of a musical instrument and/or a computing device comprising a graphical user interface), a location sensor (e.g., a GPS sensor), time sensors (e.g., a digital clock), camera sensors (e.g., cameras on a mobile computing device), device interaction sensors (e.g., a touch screen and/or retinal scanner on a mobile computing device, such as a smartphone), and/or a combination of these sensors, among other possibilities.

The processor 102 can include a general-purpose processor (e.g., a microprocessor) and/or a special-purpose processor (e.g., a digital signal processor (DSP)). The processor 102 can execute program instructions included in the data storage unit 104 as discussed below.

The data storage unit 104 can include one or more volatile, non-volatile, removable, and/or non-removable storage components, such as magnetic, optical, and/or flash storage, and/or can be integrated in whole or in part with the processor 102. Further, the data storage unit 104 can take the form of a non-transitory computer-readable storage medium, having stored thereon program instructions (e.g., compiled or non-compiled program logic and/or machine code) that, upon execution by the processor 102, cause the computing device 100 to perform one or more acts and/or functions, such as those described in this disclosure. These program instructions can define, and/or be part of, a discrete software application. In some instances, the computing device 100 can execute program instructions in response to receiving an input, such as an input received via the communication interface 106 and/or the user interface 108. The data storage unit 104 can also store other types of data, such as those types described in this disclosure.

The communication interface 106 can allow the computing device 100 to connect with and/or communicate with another entity, such as another computing device, according to one or more protocols. In one example, the communication interface 106 can be a wired interface, such as an Ethernet interface. In another example, the communication interface 106 can be a wireless interface, such as a cellular or WI-FI interface. In this disclosure, a connection can be a direct connection or an indirect connection, the latter being a connection that passes through and/or traverses one or more entities, such as a router, switch, or other network device. Likewise, in this disclosure, a transmission can be a direct transmission or an indirect transmission.

The user interface 108 can include hardware and/or software components that facilitate interaction between the computing device 100 and a user of the computing device 100, if applicable. As such, the user interface 108 can include input components such as a keyboard, a keypad, a mouse, a touch-sensitive panel, and/or a microphone, and/or output components such as a display device (which, for example, can be combined with a touch-sensitive panel), a sound speaker, and/or a haptic feedback system.

The computing device 100 can take various forms, such as a workstation terminal, a desktop computer, a laptop, a tablet, and/or a mobile smartphone. Additionally, as used herein, “mobile computing device” describes computing devices that are highly mobile (including a laptop, a tablet, and/or a mobile phone), as well as computing devices that are not as mobile (including a desktop computer, etc.). In a further aspect, the features described herein may involve some or all of these components arranged in different ways, including additional or fewer components and/or different types of components, among other possibilities.

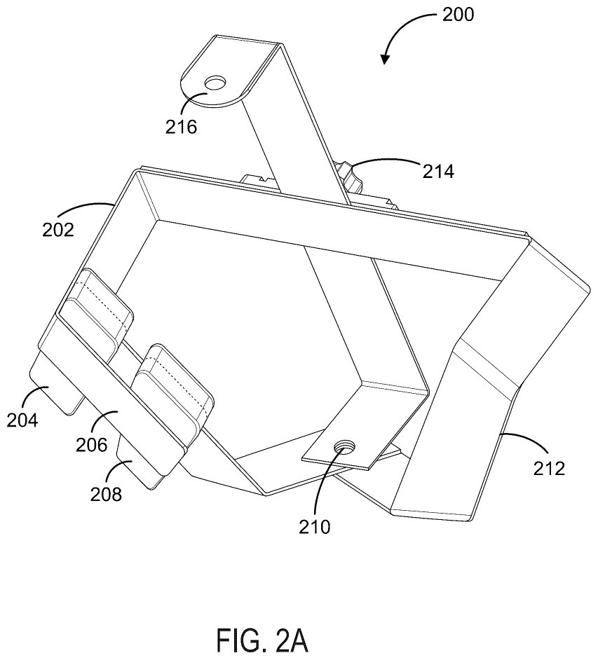

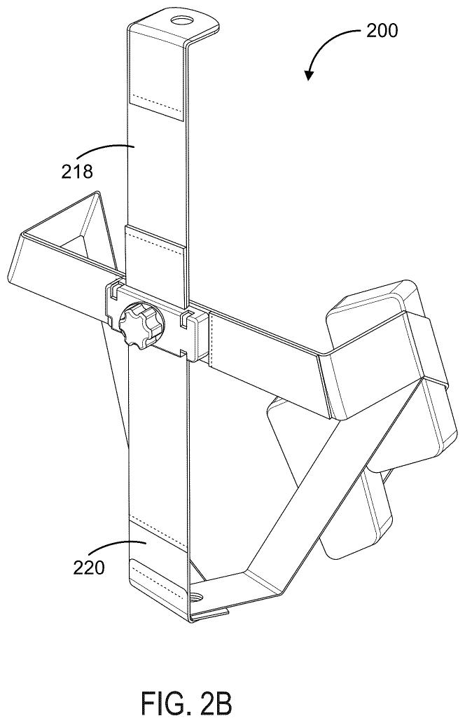

FIG. 2A provides a removable adaptation device for positioning a user's forearm, wrist, and/or hand in relation to a guitar according to the disclosure. The features described herein can involve environments, operations, and functionalities configured or formatted differently, include additional or fewer components, include different types of components, and relate to one another in different ways. The device 200 attaches to a musical instrument, such as a guitar, and positions a guitar user's strumming/picking hand and forearm to improve forearm, wrist, and hand dexterity and competence, as well as overall playing ability and form, all of which is self-contained and does not require major modification of existing systems and/or the guitar itself, to do so.

In an example embodiment, as illustrated in FIG. 2A, the device 200 may include a first strap 202, a first pad 204, a second pad 208, a securing portion 206, a first connector 210, a second strap 212, an adjustment mechanism 214, and a second connector 216. FIG. 2A, however, depicts only one example configuration, and other configurations are possible.

In this embodiment, the first strap 202, the first pad 204, the second pad 208, the securing portion 206, the first connector 210, the second strap 212, the adjustment mechanism 214, the second connector 216, and/or other components may be provided in the form of cotton, leather, vinyl, and/or plastics typically used guitar straps, but it should be understood that any of these components may be made of other materials.

Furthermore, the first strap 202, the first pad 204, the second pad 208, the securing portion 206, the first connector 210, the second strap 212, the adjustment mechanism 214, the second connector 216, and/or other components may also be modified to interact with a variety of musical instruments, guitar types, styles, and configurations (e.g., acoustic guitars, electric guitars, bass guitars, etc.), and the shape and/or dimensions of any component of device 200 can be modified to fit in or integrate with any musical instrument or guitar.

Turning to the operation of device 200, the device 200 fits over a guitar body with the first strap 202 overlying a first portion of the guitar with the first pad 204 and the second pad 208 aligning where the guitar user's forearm would be (e.g., normally or regularly) placed when playing. The first pad 204 and the second pad 208 are also attached to the securing portion 206 to further secure the guitar user's forearm when the forearm is placed between the first pad 204 and the second pad 208. The first strap 202 also joins the first connector 210, which is coupled to a first point (e.g., in a first portion) of the guitar body (e.g., shown here as a strap button perforation that connects to a strap button on the bottom-most portion of the guitar body).

The device 200 also securely fits over the guitar body with the second strap 212 overlying a second portion of the guitar. The second strap 212 also joins the first connector 120, which is coupled to the first point of the guitar body (shown here, again, as a strap button perforation that would connect to a strap button on the bottom-most portion of the guitar body).

The device 200 also contains the adjustment mechanism 214 that overlies a third portion of the guitar (e.g., is placed behind the guitar body) and is connected to the first strap 202 and the second strap 212. Adjustment mechanism 214 also joins the second connector 216, which is coupled to a second point of the guitar body (e.g., shown here, as a strap button perforation that connects to a strap button on the top-most portion of the guitar body, near where the guitar body joins the guitar neck).

In operation, once the device 200 is attached to the guitar, the user can adjust the tension of the device components by adjusting the adjustment mechanism 214. For example, in this embodiment, the adjustment mechanism 214 is illustrated as a geared mechanism. In this embodiment, the user would turn the knob of the adjustment mechanism 214 clockwise, which would in turn pull one or more of the first strap 202, the first connector 210, the second strap 212, the second connector 216, and/or the adjustment mechanism 214 more taunt in relation to one another, thereby further tightening and securing the device 200 in relation to the guitar body. Additionally or alternatively, once the device 200 is sufficiently and securely attached in relation to the guitar body, before playing the guitar using device 200, the user may place the forearm of their strumming/picking hand in between the first pad 204 and the second pad 208, and then further secure the forearm in between the first pad 204 and the second pad 208 using the securing portion 206. Other examples and configurations are possible.

For example, turning to FIG. 2B, FIG. 2B provides a removable device for positioning a user's forearm, wrist, and/or hand in relation to a guitar similar to the device described in FIG. 2A. The features described in FIG. 2B can involve environments, operations, and functionalities that are configured or formatted differently, include additional or fewer components, include different types of components, and relate to one another in different ways. The device 200 in FIG. 2B attaches to a guitar and positions a guitar user's strumming/picking hand and forearm to improve forearm, wrist, and hand dexterity and competence, as well as overall playing ability and form, all of which is self-contained and does not require major modification of existing systems and/or the guitar itself, to do so.

In an example embodiment, the device 200 as illustrated in FIG. 2B, like device 200 in FIG. 2A, may be made up of a first strap, a second strap, a first connector, a second connector, and an adjustment mechanism 214. Unlike FIG. 2A, however, FIG. 2B contains a first elastic portion 218 and a second elastic portion 220. Again, however, FIG. 2B depicts only one example configuration, and other configurations are possible (and may even be preferable).

Turning to the operation of device 200, the device 200 fits over a guitar body with the first strap overlying a first portion of the guitar and the second strap overlying a second portion of the guitar. The first strap and the second strap also join the first connector, which is coupled to the first point of the guitar body. The device 200 also contains the adjustment mechanism that is placed behind the guitar body and is connected to the first strap and the second strap. In FIG. 2B, however, the adjustment mechanism also joins the third strap (containing a first elastic portion 218) and a fourth strap (containing a second elastic portion 220).

In operation, in attaching the device 200 to the guitar, the user has the added benefit of adjusting the tension of the device components by attaching the first connector to the first connection point (shown here as a strap button perforation that connects to a strap button on the bottom-most portion of the guitar body) and attaching the second connector to the second connection point (shown here, again, as a strap button perforation that would connect to a strap button on the bottom-most portion of the guitar body). In doing so, the device 200 may be more suited to accommodate different body shapes and styles as the first elastic portion 218 and the second elastic portion 220 may provide for a greater range of displacement between the first connection point and the second connection point when attaching the device 200 to the guitar. Other examples and configurations are possible.

Further, in this embodiment, the adjustment mechanism is illustrated as a geared mechanism, so when the user turns the knob of the adjustment mechanism clockwise, the first strap, the second strap, the first connector, the second connector, the adjustment mechanism, the third strap, the first elastic portion 218, the fourth strap, and/or the second elastic portion 220 more taut in relation to one another, thereby further tightening and securing the device 200 in relation to the guitar body. Other examples and configurations are possible.

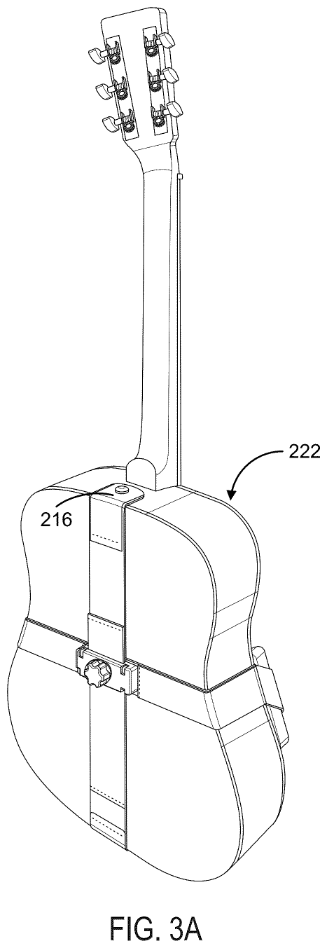

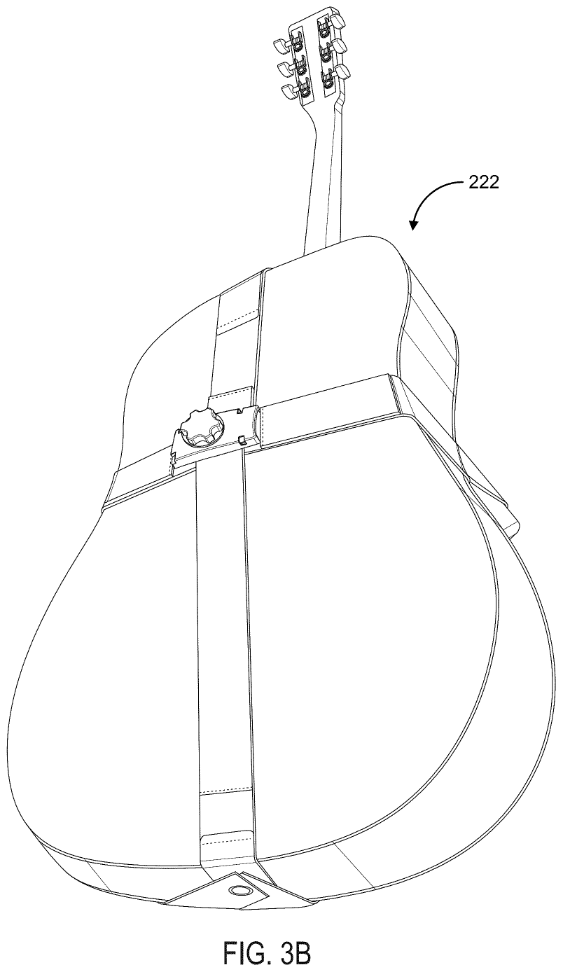

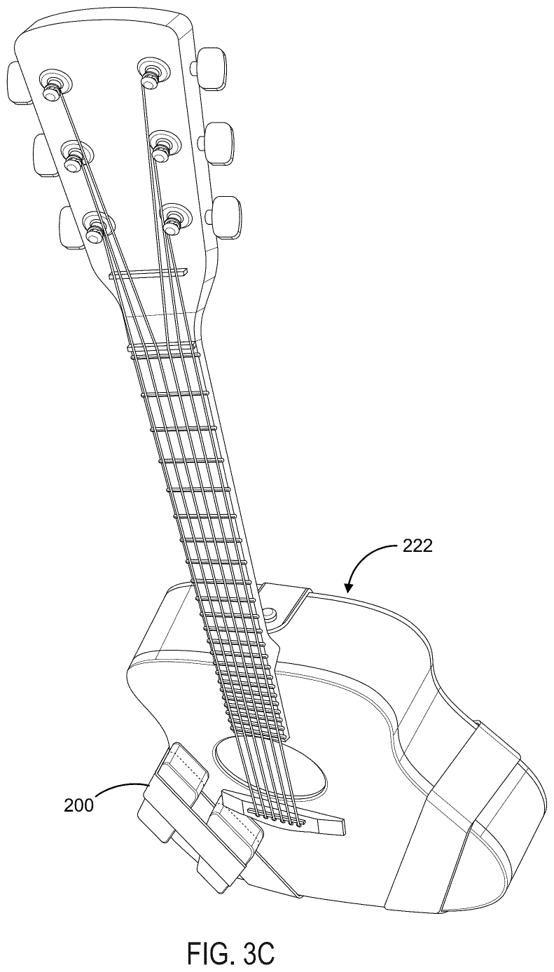

FIGS. 3A, 3B, and 3C are various views of example embodiments of an adaptation device, such as the adaptation device 200 shown in FIGS. 2A and 2B, coupled to (e.g., positioned on) an example guitar.

For example, FIGS. 3A-3C provide an adaptation device 200 that is removable for positioning a user's forearm and hand in relation to a guitar similar to the device 200 provided in FIGS. 2A and 2B, except as attached to an example (e.g., dreadnought) shaped acoustic guitar. The features described herein can involve environments, operations, and functionalities that are configured or formatted differently, include additional or fewer components, include different types of components, and relate to one another in different ways.

The device 200 (e.g., removably) attaches to a guitar and positions a guitar user's strumming/picking hand and forearm to improve forearm, wrist, and hand dexterity and competence, as well as overall playing ability and form, all of which is self-contained and does not require major modification of existing instruments (e.g., systems) and/or the guitar itself, to do so.

Turning to FIG. 3A, in this embodiment, the second connector 216 is shown as coupled to a strap button on the top-most portion of the guitar body 222, near where the guitar body joins the guitar neck. Again, however, the second connector may attach to the guitar body and/or guitar neck using connections other than a strap button. For example, the second connector may attach to the guitar using an adjustable lanyard that extends around from the back of the guitar body and attaches to one or more features on the top portion of the guitar. In a further aspect, the second connector may be adjustable and can attach to these features on the top portion of the guitar using materials and/or mechanisms that do not harm or require any modification of the guitar itself.

Turning to FIG. 3B, in this embodiment, the first connector is shown as coupled to a strap button on the bottom-most portion of the guitar body. Although the first connector is illustrated to connect with a strap button, in should be understood that the first connector can connect with a variety of types of strap button (e.g., Fender®-style strap buttons, Gibson®-style strap buttons locking strap buttons, etc.) and/or other components (e.g., an input jack for an instrument cable).

Turning to FIG. 3C, in this embodiment, the first strap is shown as overlying a first portion of the guitar body with the two pads aligning where the guitar user's forearm would normally be placed when playing and attached thereto a securing portion that further secures the guitar user's forearm when the forearm is placed between the two pads. Additionally, in FIG. 3C, the second strap is shown as overlying a second portion of the guitar body. Other examples and configurations are possible.

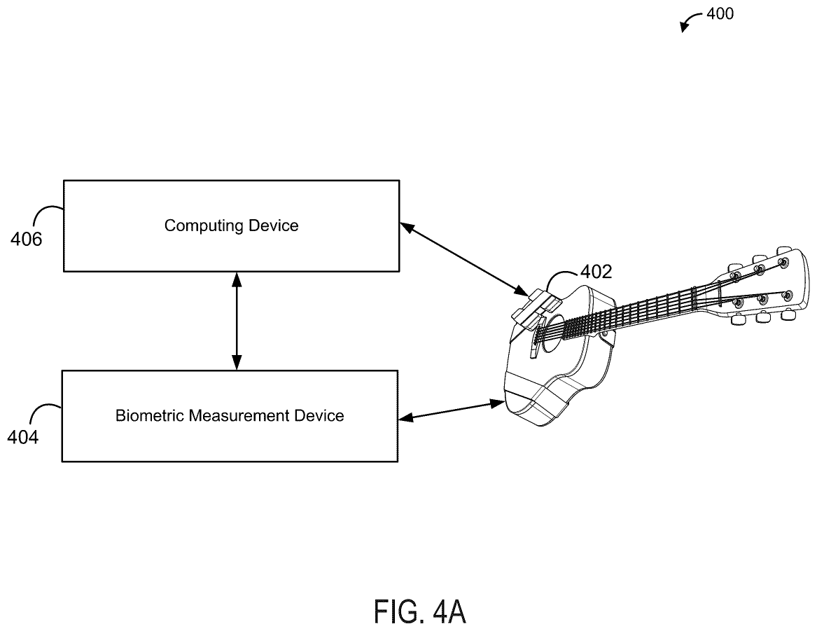

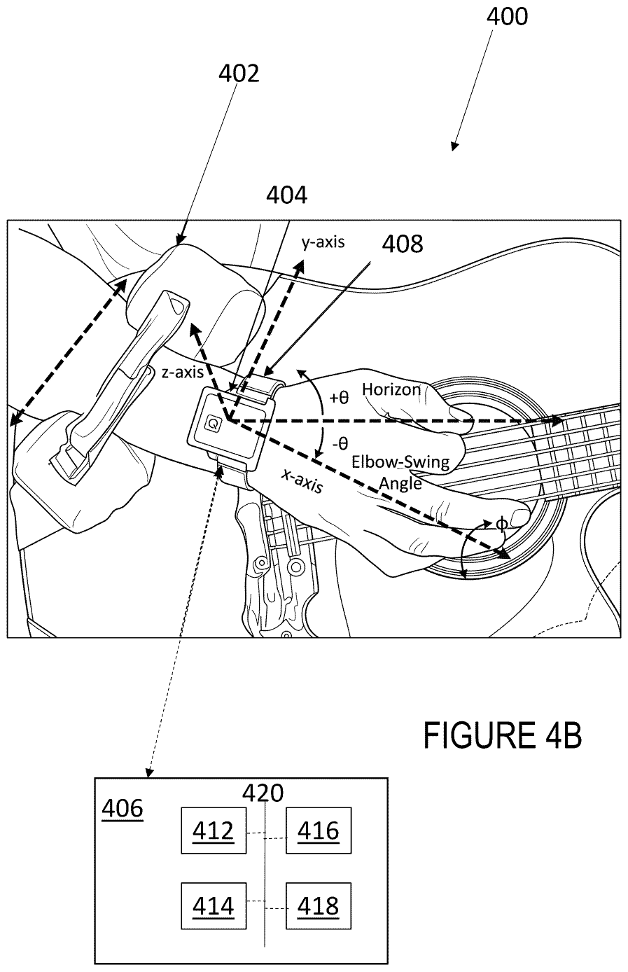

Turning to FIGS. 4A and 4B, in an example embodiment, a musical instrument improvement system (e.g., an adaptation system) 400 is provided. The musical instrument improvement system 400 may include a guide device (e.g., adaptation device) 402, a biometric measurement device 404 (e.g., inertial wrist sensor), and a computing device 406 (e.g., a display or the like) having an optional graphical user interface. The system 400 may include one or more devices shown in FIGS. 1-3C, for positioning a user's forearm, hand, and/or wrist in relation to the musical instrument, such as a guitar, monitoring the movement of one or more of these appendages, and/or providing feedback and/or instructions to the user based on the same. Many examples are possible.

Turning to the operations of these components, in FIG. 4B, the biometric measurement device 404 is configured to monitor, measure, record, and/or store movement data (e.g., dynamics) of at least one of the forearm, wrist, and/or hand of the user when the user strums the guitar or plays a musical instrument, and the computing device 406 is configured to provide (e.g., real-time) feedback to the user regarding the user's forearm, wrist, and/or hand position and/or movement. The feedback may indicate a user's efficiency in learning and/or playing the guitar, monitor the user's progress, prevent or minimize injury, aid in therapy, and, in some instances, identify and/or treat a neurological condition. Moreover, the system 400 can be utilized in both online and in-person learning or therapy environments, including for individuals with movement disorders or neurological conditions, to support more effective and accessible instruction and/or exercises. For example, movement disorders and/or neurological conditions may include individuals with Parkinson's disease, and/or individuals who have experienced a traumatic brain injury (TBI) and/or a stroke, although other disorders and/or conditions are possible.

In an example embodiment, the guide device 402 shown in FIGS. 4A and 4B may be the device 200 shown in FIGS. 2A, 2B, 3A, 3B, and 3C, for positioning a user's forearm, hand, and/or wrist in relation to the musical instrument, such as a guitar.

The biometric measurement device 404 is configured to monitor, measure, record, and/or store movement data and/or positioning data of a user's forearm, wrist, and/or hand, preferably when the user is playing a guitar. For example, the biometric measurement device 404 may capture details of the guitar user's strumming motion (e.g., down strumming data, up strumming data, and/or a combination thereof), strumming rhythm, and/or other data.

In one aspect, the biometric measurement device 404 may be sized and shaped to be wearable by a user to ensure accurate data collection. The biometric measurement device 404 may be provided as a small, thin, and lightweight device to prevent interference with the user's guitar playing. For example, the device 404 may be substantially rectangular with a size of about 2.5 centimeters by 2.5 centimeters and weigh between about 20 grams and about 30 grams, or about 24 grams. Other sizes, shapes, and weights are possible for the biometric measurement device 404.

Further, the device 404 may include at least one slot or a pair of slots to accommodate a strap 408 therein. In one aspect, the strap 408 may be contoured to securely fit around the user's wrist, wherein the device 404 may be positioned on the back of the user's wrist, and the strap 408 may be adjustable to accommodate different wrist sizes. For example, the strap 408 may be provided in the form of a flexible, lightweight material (e.g., rubber, vinyl, plastic, foam, cotton, a combination thereof, and/or other suitable materials) to be comfortable when worn and be easily cleaned. In another aspect, the strap 408 may be provided in another material and/or shaped and sized differently.

In one embodiment, the biometric measurement device 404 may be a watch, such as a digital watch or a smartwatch, which may be worn on the wrist.

To facilitate recording and storing a user's strumming motion, the biometric measurement device 404 includes at least one sensor (e.g., a motion sensor), at least one processor (e.g., a microprocessor), an optional connectivity module to track and analyze movement patterns, and a memory, such as those described with respect to the computing device 100 of FIG. 1. Further, the biometric measurement device 404 may include a rechargeable battery and/or a camera to capture images or video of the wrist movement of the user. The biometric measurement device 404 may include greater or fewer components.

The biometric measurement device 404 may be configured to collect (e.g., raw motion strumming) data via the at least one sensor, such as an accelerometer (e.g., 3-axis or 6-axis MEMS) and/or a gyroscope (e.g., 3-axis). In an example embodiment, the data may be sampled at about 1024 Hz and may be stored onto an internal memory card of the device 404. The accelerometer may detect (e.g., linear) acceleration in a plurality of directions (e.g., an x-direction (x-axis), a y-direction (y-axis), and/or a z-direction (z-axis) as shown in FIG. 4B), and the gyroscope may measure angular velocity. Other additional or alternative sensors may be included in device 404, such as a magnetometer and/or an optical heart rate sensor to monitor pulse variations related to strumming movement.

Once the data is captured by the one or more sensors, the data may be evaluated to assess the strumming technique of the user of the guitar. To assess the strumming technique, the processor (e.g., embedded low-power microcontroller) of the biometric measurement device 404 may use a sensor fusion technique to provide real-time calculation of a plurality of parameters (e.g., angles) of the device 404 relative to the ground (e.g., horizon). The plurality of parameters may include, among possible other parameters, an elbow swing angle (θ) to provide insights into elbow movement during strumming, a wrist swing angle (φ) to characterize wrist movement dynamics during strumming, and an orbit coefficient calculated as Δφ/Δθ, where Δφ represents the change in the wrist-twisting angle and Δθ represents the change in the elbow-swinging angle. Thus, the orbit coefficient quantifies the relationship between wrist-twisting and elbow-swinging angles during guitar strumming, indicating the influence of each motion component on strumming and providing a numerical representation of strumming dynamics in a three-dimensional (3D) space.

An increase in the orbit coefficient indicates a greater focus on wrist-twisting than elbow-swinging movements and suggests that a user's strumming motion is becoming more controlled and stable, with the wrist and elbow movements more harmoniously integrated. A higher orbit coefficient further reflects improved coordination and a more predictable strumming pattern, which can enhance the overall consistency and quality of the strumming technique.

Although a sensor fusion technique is disclosed hereinabove, other possible techniques using one or more algorithms may be used by the processor of the biometric measurement device 404 to measure, calculate, and/or evaluate one or more additional parameters.

For example, additional parameters may include rhythm deviation indicating the difference between the intended beat and the actual played notes which may be useful for analyzing timing accuracy, sharpness indicating the abruptness of wrist or finger motion when changing strumming direction or transitioning between notes, tracing of movement within an x/y-direction (e.g., x/y-axis) indicating motion path of the hand or pick across the guitar strings to analyze picking patterns, sweep picking, and/or strumming consistency, at least one 3D rendering indicating a digital visualization of a guitarist's hand, wrist, forearm, and/or finger movement in three dimensions (e.g., an x-direction, a y-direction, and/or a z-direction as shown in FIG. 4), live motion tracking indicating (e.g., real-time) output of the user playing the guitar, angular jerk indicating the rate of change of angular acceleration in wrist and/or elbow movement which may infer the smoothness in strumming and picking, and/or the like.

Data measured, calculated, and/or evaluated by the at least one sensor and/or the processor of the biometric measurement device 404 may be stored in the memory of the biometric measurement device 404. For example, the memory may be an internal 32 GB microSD card.

Further, the biometric measurement device 404 may record data in predetermined time increments, such as between about 30 seconds and about 20 minutes, between about 45 seconds and about 5 minutes, or about 1 minute. Additionally or alternatively to recording data in predetermined time increments, the biometric measurement device 404 may record data for as long as a user is playing the guitar.

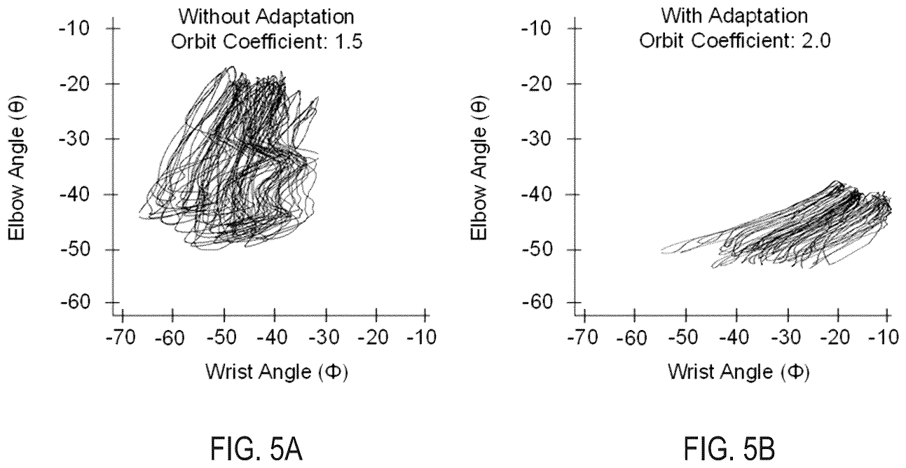

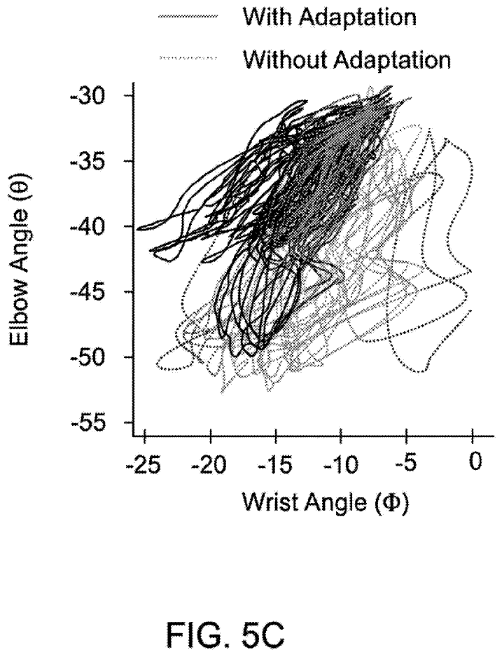

FIG. 5A is a graph of measurements measured with the biometric measurement device 404. The measurements include the user's wrist angle with respect to the user's elbow angle when playing a musical instrument without a guide or adaptation device. In comparison, FIG. 5B is a graph of measurements measured with the biometric measurement device 404 of the user's wrist angle with respect to the user's elbow angle when playing a musical instrument with a guide or adaptation device.

In comparing the data shown in FIG. 5A to the data shown in FIG. 5B, the user's orbit coefficient increased from 1.5 to 2.0, indicating an improvement in the user's elbow angle and wrist angle when the user used the guide device 402 during strumming. The improvement is indicative of an improvement in the user's guitar strumming, which also may indicate improvement in the user's learning and efficiency in playing the guitar. Further, the improvement in strumming may reduce or minimize injury to the user. The data, along with the graph, may be stored in the memory of the biometric measurement device 404.

Turning to FIG. 5C, FIG. 5C is a graph of measurements measured with the biometric measurement device of a user with Parkinson's disease. The graph indicates the user's wrist angle with respect to the user's elbow angle when playing a musical instrument with a guide or adaptation device, as shown in black, and also without a guide or adaptation device, as shown in red. Comparing the data shown in red and the data shown in black in FIG. 5C, there was less variation in the elbow angle and wrist angle when the Parkinson's disease user used the guide device 402. Reducing the variation in the elbow angle and the wrist angle are indicative of improvement in the user's guitar strumming, which may indicate improvement in the user's learning, indicate efficiency in playing the guitar, reduce or minimize injury of the user, aid in therapy, identify and/or treat the user's neurological condition, and/or provide encouragement to the user.

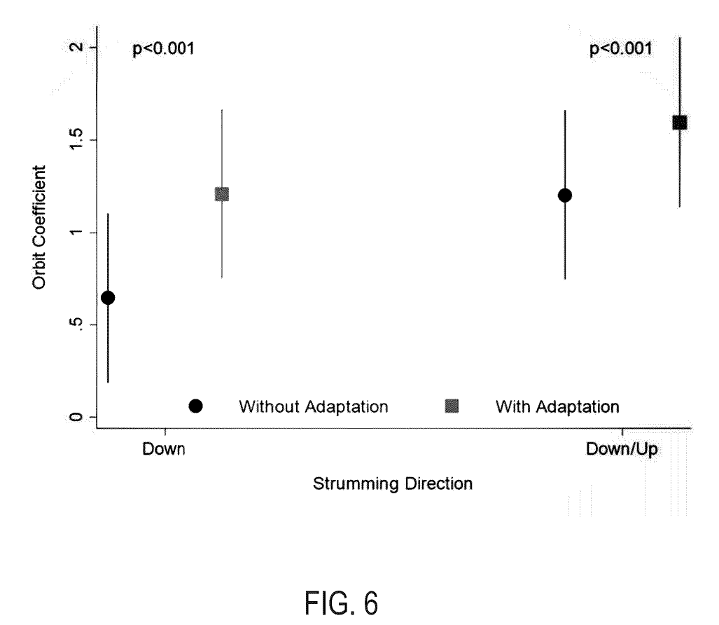

FIG. 6 is a graph of measurements measured with the biometric measurement device of a user's down strumming of a guitar showing the user's orbit coefficient both with and without the guide or adaptation device, and FIG. 6 also graphs the measurements of the user's up and down strumming of a guitar versus a user's orbit coefficient both with and without the guide or adaptation device. As shown, the user's orbit coefficient increased for down strumming when the guide device 402 was used, as well as the user's orbit coefficient increased for down and up strumming when the guide device 402 was used. Similar to FIGS. 5A, 5B, and 5C, the increase in orbit coefficient shows an improvement in the user's elbow angle and wrist angle when using the guide device 402 and thus, an improvement in the overall consistency and quality of the user's strumming technique.

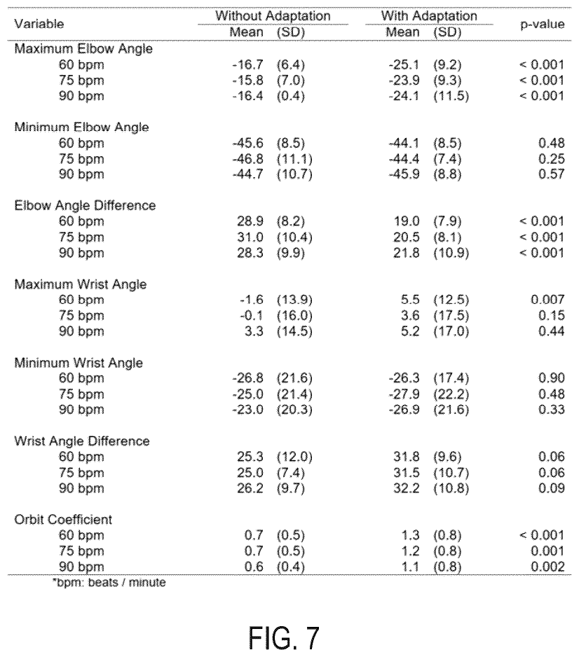

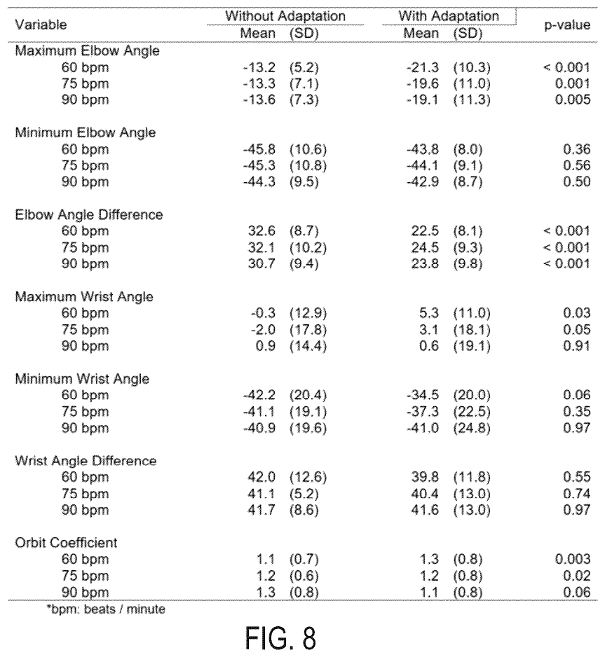

FIGS. 7 and 8 are tables of various elbow and wrist angles, in degrees, during a user's down strumming of a guitar across different frequencies with and without the guide or adaptation device. As the tables show, even at varying frequencies (e.g., guided by a digital metronome), measured at 60 beats per minute (bpm), 75 bpm, and 90 bpm, the user's elbow and wrist angles improved when the user used the guide device 402, as indicated by the increase in orbit coefficient.

The biometric measurement device 404 may further be configured to collect the user's strumming data and compare the collected strumming data to predetermined strumming data. The predetermined data may provide boundaries indicating a maximum elbow swing angle, a minimum elbow swing angle, a maximum wrist swing angle, a minimum wrist swing angle, and/or an orbit coefficient. In an example embodiment, the predetermined data may include the user's own previous strumming data. In another example embodiment, the predetermined data may be data collected from other guitar players. If the collected user strumming data is outside any one of the predetermined data boundaries, then the user may be strumming in a way that could cause injury and/or be inefficient.

Moreover, the predetermined data may be a set of strumming data from Parkinson's patients or patients with known movement disorders. In this case, the collected user strumming data may be compared to the known predetermined strumming data of Parkinson's patients, such that if the user's collected data falls within the known predetermined strumming data for Parkinson's or movement disorder patients, the collected strumming data may be indicative of a neurological condition or movement disorder.

Once the biometric measurement device 404 has collected strumming data for a user of the guitar, the biometric measurement device 404 may provide real-time feedback (e.g., audio feedback and/or haptic feedback) to the user. For example, when predetermined movement thresholds, such as a maximum wrist swing angle, are reached or exceeded, an alert may be provided to the user via the biometric measurement device 404 and/or via the computing device 406. The alert may be audible, a vibration, a flashing light, and/or a combination thereof. When the user receives the alert as (e.g., real-time) feedback, the user may be warned and/or instructed to adjust or reposition at least one of the user's forearm, wrist, and/or hand (e.g., within the guide or adaptation device) to improve the user's strumming.

In addition to collecting and storing the strumming data, the biometric measurement device 404 may be configured to transmit the collected and/or stored data. For example, the biometric measurement device 404 may be in two-way communication with the computing device 406. For example, the data may be locally or wirelessly transmitted to the computing device 406 via Bluetooth, Wi-Fi, or NFC for (e.g., real-time) displaying or outputting of the strumming data.

Turning to the computing device 406, in an example embodiment, the computing device 406 may be the computing device 100 of FIG. 1 and may include greater or fewer components and/or peripheral devices.

The computing device 406 is configured to provide (e.g., real-time) feedback to the user regarding the user's forearm, wrist, and/or hand position and/or movement gleaned from the biometric measurement device 404.

In an example embodiment, the computing device 406 may be any type of computational platform. In this example, computing device 406 may include a processor 412, memory 414, network interface 416, and an input/output unit 418, all of which may be coupled by a system bus 420 or a similar mechanism.

Network interface 416 of the computing device 406 may take the form of one or more wireline interfaces, such as an Ethernet connection. Network interface 416 may additionally take the form of one or more wireless interfaces, such as Wi-Fi, Bluetooth®, global positioning system (GPS), or a wide-area wireless interface. However, other forms of physical layer interfaces and other types of communication protocols may be used over network interface 416. Furthermore, network interface 416 may include Ethernet, Bluetooth®, and Wi-Fi interfaces. When the biometric measurement device 404 transmits the strumming data (e.g., wrist, hand, and/or forearm movement data and/or wrist, hand, and/or forearm positioning data) to the computing device 406, the data may be output via the computing device 406, such as via the user interface (e.g., the user interface 108 of the computing device 100)

Once the data is output via a display or user interface of the computing device 406, the user may interact with or view the data captured by the biometric measurement device 404, such as through a graphical user interface. The graphical user interface may be provided in various formats, such as with icons, in graphical format such as graphs and/or charts, tables, dashboard, infographics, maps, diagrams, animations, models, a combination thereof, or the like. The computing device 406 provides the user with a plurality of options to interpret and/or view his/her strumming data.

Further, once the strumming data is provided to the computing device 406, the user and/or another (e.g., additional) individual, such as a teacher, doctor, or therapist, who may be in-person or remote, may view the strumming data and/or may assess the strumming data, including assessing whether the strumming data falls within predetermined parameters. In examples, the additional individual may also be able to access the user's history and compare the user's current strumming data with the user's prior strumming data and/or other users'prior strumming data.

When at least a portion of the strumming data falls outside predetermined parameters, the computing device 406 and/or the additional individual may provide instructions for the user to modify the position of the guide or adaptation device and/or modify the position of at least one of their forearm, wrist, and/or hand to prevent injury or the like when playing the guitar.

Moreover, when at least a portion of the strumming data falls outside predetermined parameters, the computing device 406 and/or the additional individual may recommend a therapy treatment plan. The therapy treatment plan may provide the guitar user with a plurality of successive lessons to improve the user's strumming technique and minimize injury potential.

Further, when at least a portion of the strumming data tracks data that is known to be associated with users having Parkinson's disease or a neurological condition, a warning or message may be provided via the computing device 406 that the user's strumming motion tracks that of a person with a neurological condition or movement disorder. Also, in examples, the additional individual may provide (e.g., verbal) feedback to the user when the user's strumming motion tracks that of a person with a neurological condition or a movement disorder.

In addition to receiving and/or displaying strumming data from the biometric measurement device 404, the computing device 406 may perform some or all of the functions of the biometric measurement device 404. For example, the computing device 406, in addition to or as an alternative to the biometric measurement device 404, may monitor, measure, record, and/or store movement data of at least one of the forearm, wrist, and/or hand of the user when the user strums the guitar, and/or the computing device 406 may analyze (e.g., calculate or evaluate) the strumming data. Other examples are possible.

The biometric measurement device 404 additionally or alternatively may transmit the strumming data (e.g., wirelessly) to another computing device.

Moreover, in some embodiments, computing device 406 may be configured to receive inputs and/or outputs from not only the biometric measurement device 404 but may receive inputs and/or outputs from additional electronic devices, such as mobile cellular phones, smartwatches, laptops, or personal handheld devices.

In an example embodiment, the computing device 406 may facilitate online remote learning, therapy, or treatment for a guitar user, including for individuals with movement disorders or neurological conditions, to support more effective and accessible instruction. For online remote learning, therapy, or treatment, the user may use the guide device 402 and/or wear the biometric measurement device 404, which may output collected data to the computing device 406. The computing device 406 may be in communication with a remote device or a device in a location different than the location of the user. The remote device may display the collected data. Another (e.g., additional) individual, such as a teacher, therapist, or doctor, may be in the remote location (e.g., during a telehealth visit or a teletherapy visit), and the additional individual may view the remote device and then may provide (e.g., immediate and/or real-time) feedback to the user on the data collected from the biometric measurement device 404. In examples, feedback may also be provided to the user at a later time, among other possibilities.

For example, in embodiments, such feedback, based on data or information collected via the biometric measurement device, may identify changes in upper-extremity motor performance and evaluate the user's target engagement following rhythm-based guitar training.

In examples, feedback to the user (e.g., who may have PD and/or a neurological condition) and/or another individual, via the adaptation system 400, may include providing (e.g., delivering) a rhythm-based upper-extremity motor timing intervention to the user to improve the user's health. In examples, improvements in upper-extremity motor performance may indicate a non-pharmacological approach that integrates mind-body and sensorimotor processes to improve the health of the user and/or treat the user's condition or disorder. For example, the user's motor timing, rhythmic auditory control, and/or upper-extremity rhythmic motor control may be improved through use of the adaptation system 400.

Moreover, the computing device 406 and/or the biometric measurement device 404 may be implemented in and/or in connection with one or more machine learning models. These machine learning models may include and/or be executed via a non-transitory computer-readable storage medium and one or more processors coupled to the non-transitory computer-readable storage medium. In examples, these non-transitory computer-readable storage medium comprise program instructions that, when executed on one or more processors, cause the system to perform operations including training a collection of machine learning algorithms using training data (e.g., strumming data sets) provided from one or more computing devices (e.g., the biometric sensing device 404).

In example embodiments, the machine learning model may be trained to observe, capture, analyze, and/or take one or more computational actions based on one or more attributes of the user in connection with the training device and/or one or more computing devices described herein. These examples include one or more of: (1) discriminating between a user's strumming motion and/or strumming rhythm and the user's previous strumming motion and/or rhythm identifying patterns of change in strumming motion and/or rhythm, (2) discriminating between a user's strumming motion and/or a predetermined strumming motion and/or rhythm identifying patterns of change, and/or (3) discriminating between a strumming motion and/or strumming rhythm of a user without a neurological condition and a strumming motion and/or rhythm of a user with a neurological condition, such as Parkinson's disease, by identifying patterns which are indicative of the presence of the neurological condition. Once patterns are identified, these patterns may be labelled and/or further analyzed in one or more ways, including as a feature set. Other examples are possible.

For example, in cases where a particular training protocol and/or an associated neurological condition associated with a user can be confidently identified based on the strumming data set (e.g., a user with a neurological condition), the associated data set may then be used to (e.g., continually) train the machine learning model to identify other users with the neurological condition based on strumming data sets. In example embodiments, once the model has received and/or otherwise collected data from various resources (e.g., via a modeling computing device), the model may also be used also generate and maintain one or more programs to interpret this data (e.g., one or more programs securely stored on a server and/or database associated with the modeling computing device, the user and/or an associated entity-for example, an associated healthcare provider, trainer, etc.). For example, the modeling computing device may use one or more machine learning models to interpret this data and generate one or more models based on this collected data.

For example, to do so, the model may use image and/or video data associated with a particular user to utilize and/or train a machine learning model to generate one or more recommended treatment protocols and/or training exercise that that employee a more dynamic and comprehensive protocol to address one or more issues identified in the user, including in the user's strumming and/or playing patterns. To do so, in examples, the model may analyze one or more features of a video (e.g., on a plurality of 2D images of the user while playing an instrument). In this regard, machine learning models may allow high accuracy and dynamic features of the user's strumming and/or playing patterns to be analyzed using a series of images and/or short video clips.

In a further aspect, in an example embodiment, the model may be trained on data associated with the particular user and be further refined and/or trained with additional information and/or data sources (e.g., additional videos or images of the user and/or other users that share one or more attributes with the user (including one or more neurological conditions), among other possibilities.

In a further aspect, in an example embodiment, a party associated with the particular user (e.g., a physician and/or healthcare provider) may then use a computer with a 3D application (or VR headset) to remotely view the user's strumming and/or playing patterns and/or portions thereof based on these models, and may even be able to view and/or otherwise interact with the user from multiple angles displayed within the user's environment, thereby allowing the party to interact with and/or otherwise direct the user within the virtual scene.

Utilizing these models and targeted training protocol may provide one or more distinct benefits to the methods, devices, and systems described herein, including that, rather than creating a generalized model that can be applied to any user, these models can be trained on one user during one training session, which removes the requirement for large training datasets and, instead, allows a single video to train the model. Furthermore, although certain models and functionality have been detailed herein, it should be readily apparent to those of ordinary skill in the art that other machine learning models may be used in the example embodiments detailed herein.

### EXAMPLES

Various exemplary embodiments of systems and methods according to this disclosure are now described in the following non-limiting Examples. The Examples are offered for illustrative purposes only and are not intended to limit the scope of this disclosure in any way. Indeed, various modifications of this disclosure in addition to those shown and described herein will become apparent to those skilled in the art from the foregoing description and the following examples and fall within the scope of the appended claims.

### I. Example 1

### Example of Use of a Mechanical Adaptation to Enhance Guitar Learning Technique

Strumming is a guitar technique involving rhythmic motion characterized by a smooth, pendulum-like motion across multiple strings. Proper strumming integrates coordinated wrist and arm movements, with the wrist playing a useful role in dynamic equivalency during both down strumming (e.g., downstrokes) and up strumming (e.g., upstrokes). Poor strumming techniques can lead to repetitive strain injuries. This study examined the efficacy of an adaptation device (such as the Strum Perfect™) designed to optimize wrist and forearm positioning, by analyzing its impact on strumming mechanics among guitarists with varying levels of experience. Ten guitarists of diverse skill levels participated in this pre-post intervention study. Participants performed strumming exercises at 60, 75, and 90 beats per minute (bpm) using an acoustic guitar. A wrist-worn motion-sensing device recorded movement dynamics including elbow and wrist angles throughout the strumming period. The adaptation was assessed for its effect on elbow and wrist motion by comparing metrics such as maximum and minimum angles and the orbit coefficient, which quantifies motion stability. The guitar adaptation significantly reduced maximum elbow angles during down strumming across all frequencies (p<0.001), with a notable decrease in the range of elbow movement. While maximum wrist angles increased slightly at 60 bpm (p=0.007), other wrist angle differences were less consistent. The orbit coefficient, reflecting motion stability, significantly improved with the guitar adaptation (p<0.001). Similar trends were observed during alternating up-and-down strumming, with significant reductions in maximum elbow angles and increased stability. A guitar adaptation device can enhance strumming technique by reducing elbow motion range and promoting greater wrist flexibility, leading to improved stability and control. These findings provide that a guitar adaptation device can be beneficial for guitar players/users and may offer potential advantages in both learning and performance contexts.

### A. Introduction to Example 1

Strumming is a technique in playing a guitar that involves the rhythmic motion of a pick or fingers across most or all the strings. Typically, strumming patterns are characterized by a smooth, pendulum-like arcing that allows for dynamic range in the resulting sound, while minimizing fatigue. The strumming motion relies on a coordinated downward and upward movement of a user's wrist and arm. To maintain a steady rhythm across multiple strings, the strumming motion should ideally incorporate a mixture of partial arm (e.g., forearm) movement with a range of wrist movement. This approach may prevent or minimize fatigue and promote efficiency, with the wrist playing a useful role in dynamic equivalency during both down strumming and up strumming of the guitar strings.

The mechanical aspect of strumming a guitar relies on consistent stability of the elbow and wrist. Repetitive motions resulting from poor strumming techniques, such as locking the wrist and over-relying on arm movement, can lead to a range of injuries. A relaxed wrist, combined with a stable elbow, allows for a more flexible, fluid, and effective strumming motion, improving both the comfort and quality of sound produced.

To support learners in developing proper techniques, adaptations to the guitar can be instrumental, particularly if they optimize wrist and arm motion to refine strumming mechanics. One such guide device or adaptation device is the Strum Perfect™, a device designed to guide the arm and enhance wrist movement during strumming. By guiding wrist and forearm positioning, such adaptations help users maintain the optimal balance of arm and forearm movement, reducing the likelihood of adopting poor techniques. This facilitates the learning of efficient, injury-preventive strumming mechanics, particularly for beginners who might otherwise struggle with achieving the appropriate coordination and flexibility. Through enhanced stability and motion control, these adaptations provide and promote proper technique, and also provide an accelerated learning process by minimizing common frustrations and physical strain during practice.

The primary objective of this example is evaluating the effectiveness of a guide or adaptation device, such as a Strum Perfect™ adaptation, by examining the impact of the device on strumming mechanics across a spectrum of guitar users, from novices to experts. By characterizing how the adaptation device influences the range of the elbow and wrist motion, this example offers measurable improvements in strumming technique, as the adaptation device improves consistency of strumming mechanics.

### B. Methods of Example 1

### Sample

This interventional example was designed as a pre-post assessment and employed a convenient sample of ten volunteers, selected to represent a range of guitar-playing expertise, from novice to expert. Participants were recruited from a pool of students and members of the general community who expressed interest in participating in the assessment. All participants provided verbal informed consent before their involvement. To ensure uniformity in the conditions, each participant either had their own acoustic guitar or was provided with one. No physical interaction with the participants was used to direct wrist and forearm positioning, to simulate an online setting. Participants were instructed to strum the guitar using specific techniques and frequencies. The strumming exercises included a sequence of down-strumming followed by alternating down-and-up strumming, with each type of strumming performed at three pre-determined frequencies: 60, 75, and 90 beats per minute, guided by a digital metronome. This standardization aimed to eliminate variability in strumming tempo, allowing for more accurate data collection and analysis. Prior to the beginning of the assessment, each volunteer was equipped with a wrist-worn motion-sensing device (e.g., a biometric sensing device), which was used to analyze the participant's guitar strumming form (Kamo & Matsushita, 2021, 2022; Matsushita, 2019; Matsushita & Kamo, 2022; Yoshida & Matsushita, 2020). The motion-sensing device included a 3-axis accelerometer and a 3-axis gyroscope, which together provided comprehensive motion data. This wrist inertial motion sensor is accurate in capturing and analyzing the nuanced movements involved in guitar strumming. The participants wore the adaptation device on their dominant hand (e.g., near their wrist), which was the hand used for strumming, providing that the data collected would accurately reflect the strumming technique and frequency across the different skill levels.

### Guitar Adaptation

The adaptation device (e.g., guide device) for the guitar, designed with the primary objective of guiding the forearm into an optimal strumming position while providing a larger range of motion for the wrist was used to assess changes in biomechanics of strumming a guitar. This adaptation device secures the forearm against the guitar using two strategically placed foam pads and an adjustable strap. By placing (e.g., locking) the forearm into this position, the adaptation (e.g., effectively) restricts the three-dimensional range of motion and (e.g., significantly) reduces multi-planar movement, thereby limiting movement primarily to a single axis. The adaptation device guides the forearm into a proper strumming position, which helps to provide more controlled strumming in a symmetrical plane. By reducing the multi-directional movement, the adaptation device enhances control over the strumming arm and encourages more wrist movement, making guitar playing more rhythmic.

### Analysis of Strumming Patterns

For the current example, a wrist-worn wireless motion tracking device was utilized to capture the details of the participants' strumming movements. This device was equipped with a 3-axis accelerometer (±16 G) and a 3-axis gyroscope (±2000 degrees per second), providing comprehensive motion data across multiple dimensions. The device recording raw motion signals sampled at 1024 Hz onto an internal 32 GB microSD memory card (Matsushita, 2019; Yoshida & Matsushita, 2020). The high sampling frequency of 1024 Hz was chosen to provide sufficient time resolution for diagnosing the accuracy of the strumming rhythm. The relatively low weight of the device (~24 grams), ensured minimal obtrusiveness for the participants, allowing for natural guitar playing without interference. To assess the strumming technique, the device employed a sensor fusion technique, which allowed for real-time calculation of the angles of the device relative to the ground. This was achieved through an embedded low-power microcontroller. Several key parameters are derived from the inertial wrist sensor (FIG. 4). The first parameter was θ which represents the elbow swing angle and provides insights into elbow movement during strumming (Matsushita & Kamo, 2022). The second parameter was φ, which quantifies the wrist swing angle which characterizes wrist movement dynamics during strumming (Matsushita & Kamo, 2022). Finally, the orbit coefficient was calculated as Δφ/Δθ, where Δφ represents the change in the wrist-twisting angle and Δθ represents the change in the elbow-swinging angle (Kamo & Matsushita, 2022). Thus, it quantifies the relationship between wrist-twisting and elbow-swinging angles during guitar strumming, indicating the influence of each motion component and provides a numerical representation of strumming dynamics in three-dimensional space (Kamo & Matsushita, 2022). An increase in the orbit coefficient indicates a greater focus on wrist-twisting than elbow-swinging movements. This suggests that strumming motion is becoming more controlled and stable, with the wrist and elbow movements more harmoniously integrated. A higher orbit coefficient reflects improved coordination and a more predictable strumming pattern, which can enhance the overall consistency and quality of the strumming technique (FIGS. 5A and 5B).

### Statistical Analyses

Data analysis focused on the comparison of motion parameters with and without the guitar adaptation at the varying frequencies. The primary outcome measures included the reduction in multi-planar movement and the consistency of strumming rhythm at the specified frequencies (e.g., 60, 75, and 90 beats per minute). Descriptive statistics were calculated for each parameter, including means, standard deviations, and ranges for elbow and wrist angles, as well as the orbit coefficient. To evaluate the impact of the guitar adaptation on the maximum and minimum elbow and wrist angles during both down and alternating up-and-down strumming, paired t-tests were conducted comparing measurements with and without the device at the three specified strumming frequencies (e.g., 60, 75, and 90 beats per minute). The outcome measures included the maximum and minimum angles, the difference in elbow angles, wrist angles, and the orbit coefficient. For each frequency, the paired t-tests assessed differences observed in elbow and wrist angles and the orbit coefficient with and without the adaptation. Where data did not meet the assumptions of normality or equal variances, non-parametric tests, such as the Wilcoxon signed-rank test, were used as appropriate. Additionally, a repeated measures generalized linear model was used to evaluate whether the effects of the guitar adaptation varied significantly across different strumming frequencies and levels of expertise. This analysis helped determine if the adaptation's impact on strumming mechanics was consistent across the different tempo conditions and experience levels. The stability of strumming motion was further evaluated by comparing the orbit coefficient across different conditions. Changes in the orbit coefficient were analyzed using a one-way ANOVA and generalized linear models (Agresti, 2015) to determine if there were significant improvements in strumming stability with the guitar adaptation at different frequencies. All statistical analyses were conducted using Stata 17.0 software. A significance level of p<0.05 was used for all tests, and results are reported with 95% confidence intervals where applicable. See FIGS. 7 and 8.

### C. Results of Example 1

A sample of ten volunteers were included-seven men and three women. The age range of the participants spanned from 24 to 66 years with a mean age of 44.2 years (SD: 14.1). The participants' level of experience was evenly distributed across five categories: no prior experience (n=2), 3 years or less (n=2), 3 to 10 years (n=2), 10 to 20 years (n=2), and more than 20 years (n=2). This diverse range of experience levels allowed for a comprehensive assessment of the adaptation's effectiveness across a broad spectrum of guitar-playing skills.

Effects on Down Strumming

The use of the guitar adaptation had a significant impact on both elbow and wrist angles during down strumming at frequencies of 60, 75, and 90 strums per minute (as shown in FIG. 7). For the maximum elbow angle during down strumming, there was a notable decrease. At 60 strums per minute, the maximum elbow angle decreased from a mean of −16.7 degrees (SD=6.4) without the adaptation to −25.1 degrees (SD=9.2) with the device (p<0.001). Similar reductions were observed at 75 and 90 strums per minute, with mean maximum elbow angles decreasing from −15.8 degrees (SD=7.0) to −23.9 degrees (SD=9.3) and from −16.4 degrees (SD=0.4) to −24.1 degrees (SD=21.5), respectively (p<0.001 for both). These results suggest that the adaptation (e.g., significantly) restricts the maximum elbow extension during down strumming. In contrast, the minimum elbow angle during down strumming showed less variation between conditions. For instance, at 60 strums per minute, the minimum angle was −45.6 degrees (SD=8.5) without the device and −44.1 degrees (SD=8.5) with it, a difference that was not statistically significant (p=0.48). Similar trends were observed at 75 and 90 strums per minute, with no significant changes noted (p>0.05 for both). The elbow angle difference, defined as the difference between maximum and minimum elbow angles, was (e.g., significantly) reduced with the guitar adaptation across all strumming frequencies. At 60 strums per minute, the angle difference decreased from 28.9 degrees (SD=8.2) without the device to 19.0 degrees (SD=7.9) with it (p<0.001). This reduction was consistent at 75 and 90 strums per minute, indicating that the device limits the range of elbow movement, thereby promoting a more controlled down strumming motion.

With regard to wrist angles, the maximum wrist angle during down strumming increased with the use of the adaptation at 60 strums per minute, rising from −1.6 degrees (SD=13.9) without the device to 5.5 degrees (SD=12.5) with it (p=0.007). However, at 75 and 90 strums per minute, the changes in maximum wrist angle were not statistically significant (p=0.15 and p=0.44, respectively). The minimum wrist angle remained relatively stable across conditions, with no significant differences observed at any strumming frequency (p>0.05 for all comparisons). The wrist angle difference during down strumming tended to increase with the adaptation, particularly at 60 and 75 strums per minute, though these changes approached but did not reach statistical significance (p=0.06 for both). This suggests a trend towards greater wrist movement variability with the device. Finally, the orbit coefficient, which reflects the stability and predictability of the down strumming motion, increased significantly with the adaptation across all frequencies. At 60 strums per minute, the coefficient rose from 0.7 (SD=0.5 ) without the device to 1.3 (SD=0.8 ) with it (p<0.001), indicating a more consistent and controlled motion. Similar significant increases were seen at 75 and 90 strums per minute (p=0.001 and p=0.002, respectively), highlighting the effectiveness of the adaptation in enhancing down strumming stability.

### Effects on Alternate Up-and-Down Strumming

The guitar adaptation also showed significant effects on elbow and wrist angles during alternating up and down strumming at 60, 75, and 90 strums per minute, though some effects differed from those observed during down strumming alone (FIG. 8). For the maximum elbow angle during alternating strumming, there was a significant decrease with the adaptation. At 60 strums per minute, the maximum elbow angle dropped from −13.2 degrees (SD=5.2) without the device to −21.3 degrees (SD=10.3) with it (p<0.001). This reduction was consistent across 75 and 90 strums per minute, with decreases from −13.3 degrees (SD=7.1) to −19.6 degrees (SD=11.0) (p=0.001) and from −13.6 degrees (SD=7.3) to −19.1 degrees (SD=11.3) (p=0.005), respectively. The minimum elbow angle showed no significant differences between conditions at any strumming frequency (p>0.05 for all comparisons). However, the elbow angle difference, representing the range of motion, was significantly reduced with the adaptation, decreasing from 32.6 degrees (SD=8.7) to 22.5 degrees (SD=8.1) at 60 strums per minute (p<0.001). Similar reductions were seen at 75 and 90 strums per minute, indicating that the device effectively limits elbow movement during alternating strumming, similar to its effects on down strumming. For wrist angles, the maximum wrist angle increased with the adaptation at 60 and 75 strums per minute, with the most notable change at 60 strums per minute (from −0.3 degrees, SD=12.9, to 5.3 degrees, SD=11.0, p=0.03). However, the wrist angle difference remained relatively unaffected by the device across all frequencies, showing no significant changes (p>0.05 for all comparisons). Lastly, the orbit coefficient, reflecting the stability of the strumming motion, was generally higher with the adaptation, particularly at 60 strums per minute (from 1.1, SD=0.7, to 1.3, SD=0.8, p=0.003), indicating improved stability during alternating strumming as well.

### Multivariable Analyses on the Effects of the Guitar Adaptation

To examine the effects of frequency and direction of strumming, as well as the level of expertise, on how the guitar adaptation device altered strumming mechanics, multivariable analyses were conducted. The orbit coefficient, which quantifies the relationship between wrist-twisting and elbow-swinging angles during guitar strumming, served as the dependent variable. The analyses incorporated the level of expertise, direction of strumming, and frequency, with consideration of potential interactions among these variables. FIG. 6 illustrates that the orbit coefficient consistently increased with the use of the adaptation device, regardless of strumming direction. This increase indicates that the adaptation device leads to a greater emphasis on wrist-twisting movements compared to elbow-swinging movements, suggesting a shift in the mechanics of strumming. This finding highlights the adaptation device's effectiveness in modifying strumming mechanics, aligning with the observed enhancement in strumming stability across various frequencies and conditions.

### D. Discussion of Example 1

The impact of an adaptation device for acoustic guitars on forearm positioning and strumming stability, highlighting its potential for use by music educators to support students without direct guidance or input from an instructor was examined. The findings reveal that the adaptation (e.g., significantly) streamlined the range of elbow motion while promoting greater wrist flexibility and enhancing overall motion stability during guitar strumming. These results suggest that the adaptation serves as an effective tool for enhancing both the learning process and playing experience for students, whether in online or in-person settings. This adaptation applies not only to those just beginning to play guitar but also to individuals who struggle with motor control during guitar playing.

The use of adaptations to facilitate guitar strumming may be of value for students in the early stages of their musical education (Karolus et al., 2018). Currently, there are no studies that have assessed the use of adaptation to quantify improvement in mechanics of strumming patterns. While adaptations for guitars exist, they are predominantly designed for individuals with physical disabilities or limitations related to hand mobility or strength (Bell, 2014; Dechenaud et al., 2019a, 2019b; Fjellman-Wiklund & Chesky, 2006; Nishinohira et al., 2019). For example, adaptive picks have been developed to improve grip and reduce strain for players with limited hand mobility. These picks, available in ergonomic shapes, thumb loops, or even with Velcro straps, cater to players with conditions like arthritis, muscular dystrophy, or carpal tunnel syndrome, allowing them to maintain control over strumming with less physical effort. Modified fingerpicking techniques have also been created to accommodate players with limited finger movement. These techniques often involve simplifying the fingerpicking process or using fingerpicks to enhance leverage and control. For those with more severe limitations, one-handed guitar playing methods and adaptive tools, such as slides or electronic strumming devices, have been developed to allow for continued musical expression despite physical challenges (Larsen et al., 2018; Larsen et al., 2014). Additionally, the use of capos, alternate tunings, and tools that create the chords on the guitar have been methods to simplify chord shapes and reduce the physical demands of playing, offering creative possibilities for those with limited hand strength or flexibility.

Despite these methods, adaptations specifically designed to address players without disabilities are virtually non-existent. While such guitar adaptations may facilitate the musical experience in normal people (e.g., people without disabilities), it could also have substantial value in those with tremors or other involuntary movements, both in performance and practice settings. It may provide an aid in this regard, aiming to assist in controlling and stabilizing the strumming arm by limiting multi-planar movement. The results also highlight the potential of such adaptations to improve not only the playing experience, but also the learning and motivational aspects of guitar playing for individuals with motor control difficulties. Such adaptations to the guitar as examined herein could significantly enhance remote learning or therapy by providing students or patients with a tool to improve their strumming technique independently, particularly in the physical absence of an instructor, caretaker, or therapist. By limiting unwanted movement, guitar adaptations could facilitate effective learning and maintain motivation, making it an asset for remote music education, therapy, and practice. The development and further exploration of such adaptive devices could significantly enhance the accessibility of musical instruments for a wider range of players, fostering inclusivity and creativity in music education and performance.

There are several strengths found herein. A major strength is the use of an adaptive device to optimize strumming kinetics, which provides clear insights into its impact on technique. Additionally, the inclusion of participants across a range of expertise levels adds to the generalizability of the findings. Finally, the use of an inertial sensor and the assessment of effects across three frequencies of strumming provided rigorous measurements of strumming action, offering a comprehensive analysis of the device's impact on various aspects of technique and control. The use of this adaptation represents a pioneering effort in assessing improvements in strumming fundamentals of normal participants without physical guidance from an instructor, marking a significant step forward in the evaluation of adaptive devices for online musical technique and performance.

In conclusion, a guitar adaptation can enhance strumming stability and forearm positioning, offering potential improvements in learning guitar. Furthermore, this adaptation can be utilized in both online and in-person learning environments, including for individuals with movement disorders, to support more effective and accessible instruction.

### II. Example 2

### Example of Optimizing Guitar Strumming in Parkinson's Disease: A Case Series on the Benefits of Forearm Stabilization

### A. Introduction of Example 2

Guitar strumming relies on rhythmic coordination combined with fine motor control and fluid wrist and arm movement. The strumming technique involves a balanced interplay between wrist flexibility and arm motion, allowing for dynamic sound production and minimizing fatigue over time. This coordinated movement may produce consistent and fluid strumming strokes, as well as prevent strain. However, people with motor control impairments, such as those with Parkinson's disease (PD), often struggle with executing smooth, controlled movements due to tremors, rigidity, and bradykinesia. These motor symptoms, hallmark features of PD, can significantly affect fine motor tasks, including playing musical instruments like the guitar. The movement limitations experienced by patients with PD can result in improper strumming mechanics, such as over-reliance on arm motion or compensatory locking of the wrist, both of which can exacerbate fatigue and discomfort. Additionally, tremors may destabilize the wrist, leading to inconsistent strumming and difficulty maintaining a steady rhythm. These challenges not only impede the ability to learn and play guitar effectively but may also increase the risk of overuse injuries, as players may unintentionally adopt compensatory techniques to manage their symptoms. In recent years, adaptations designed to assist musicians with motor control difficulties have emerged, offering potential solutions for optimizing movement and enhancing performance. One such adaptation is the Strum Perfect™, a device designed to promote proper wrist positioning and minimize unnecessary arm movement during strumming. By restricting excessive multi-planar movement, this adaptation provides additional stability to the forearm and wrist, which could aid patients with PD in controlling tremors and improving the consistency of their strumming motion. Given the motor challenges in PD, this example aims to explore the potential benefits of the guitar adaptation in enhancing guitar-playing mechanics among this patient sample. Specifically, this example examined how this adaptation influences strumming technique and wrist stability in patients with PD with the goal of how assistive tools may facilitate musical expression in those with movement disorders.

### B. Methods of Example 2

### Sample

Four patients with Parkinson's disease were included. Participants were selected to ensure a range of motor control abilities related to their underlying disease severity. To maintain consistency throughout the study, each participant used their own acoustic guitar, or one was provided to them. The participants were asked to perform standardized strumming tasks, which included down strumming strokes at three specific tempos (e.g., 60, 90, and 120 beats per minute), with and without the guitar adaptation. These tempos were guided by a digital metronome, ensuring that the rhythm and speed of the strumming remained consistent across all participants. Participants were equipped with a wrist-mounted motion sensor designed to track forearm and wrist movements. This device, featuring both a 3-axis accelerometer and a 3-axis gyroscope, recorded the detailed motion patterns associated with guitar strumming. The motion sensor had been previously validated in studies assessing fine motor tasks, ensuring its reliability in capturing the complex wrist and arm movements typical of guitar playing. The device was positioned on the dominant hand of each participant—the hand used for strumming—ensuring the collection of relevant motion data.

### Guitar Adaptation

The guitar adaptation was designed to optimize forearm positioning and increase wrist mobility during strumming. The guitar adaptation includes two foam pads positioned to secure the forearm against the guitar, coupled with an adjustable strap that holds the arm in place. By stabilizing the forearm, the device minimizes the potential for excessive multi-directional movement, guiding the forearm's motion primarily to a single plane. The primary purpose of this adaptation is to encourage proper forearm alignment while promoting greater wrist movement during guitar playing. By constraining the forearm's movement, the device helps to prevent compensatory arm motions that may reduce efficiency and control during strumming. This adaptation ensures that strumming occurs within a controlled, symmetrical range of motion, enhancing rhythmic consistency. Thus, it allows players to maintain better control over their strumming, particularly by directing the majority of movement to the wrist, which is useful for fluidity in guitar strumming.

### Analysis of Strumming Patterns

A wrist-worn motion tracking device was used to capture strumming motion in real time. The device, equipped with a 3-axis accelerometer (±16 G) and a 3-axis gyroscope (±2000 degrees per second), provided precise motion data across multiple dimensions. Motion signals were recorded at a sampling rate of 1024 Hz onto an internal memory card, ensuring high-resolution data capable of accurately detecting subtle variations in strumming rhythm. The lightweight nature of the device (~24 grams) minimized its impact on the participants'natural guitar-playing movements. The device employed sensor fusion techniques to calculate real-time angular measurements of the forearm and wrist relative to the ground. From these data, three key parameters were derived to assess strumming dynamics. The first was θ, which represented the elbow swing angle, offering insights into the degree of elbow involvement during strumming. The second, φ, captured the wrist swing angle, reflecting the dynamics of wrist movement. The final parameter, the orbit coefficient (Δφ/Δθ), quantified the relationship between wrist twisting and elbow swinging. This ratio provided a measure of how each component contributed to the overall strumming motion, with a higher orbit coefficient suggesting greater reliance on wrist movement relative to elbow motion. An increase in the orbit coefficient indicates improved control and coordination between wrist and elbow movements, leading to more stable and rhythmic strumming. This metric served as a useful indicator of refined strumming technique, with higher values reflecting better integration of motion components, resulting in enhanced consistency and performance quality.

### Statistical Analyses

Comparisons with and without the adaptation focused on comparing motion parameters with and without the guitar adaptation in Parkinson's patients. Descriptive statistics, including medians, interquartile ranges (IQRs), and ranges, were calculated for key measures such as wrist and elbow angles, as well as the orbit coefficient, both with and without the adaptation. To compare parameters with and without the adaptation, the Wilcoxon signed-rank test was used to compare the maximum and minimum elbow and wrist angles, as well as the orbit coefficient. This was conducted for each strumming frequency (e.g., 60, 90, and 120 beats per minute) to evaluate differences in movement patterns across the three tempo conditions. The primary outcomes included the changes in wrist and elbow angles and the orbit coefficient, which were analyzed for the down strumming strokes. To further investigate the impact of the adaptation on strumming stability, changes in the orbit coefficient were also analyzed across the different strumming frequencies using the Friedman test. This allowed for the evaluation of whether the adaptation's effect on strumming mechanics varied across different tempo conditions. All analyses were conducted using Stata 17.0 software, with statistical significance set at p<0.05.

C. Results of Example 2

The study included four patients, all with Parkinson's disease, comprising of three women and one man. The age range of the participants spanned from 61 to 81 years with a mean age of 71.8 years (SD: 8.7). All of the participants had less than one year of guitar playing experience: no prior experience (n=3), 1 year or less (n=1). This focus on beginning experience levels allowed for a comprehensive assessment of the adaptation's effectiveness with people who have limited to no background playing guitar.

D. Discussion of Example 2

This example explored the benefits of a novel guitar adaptation, Strum Perfect™, on strumming biomechanics in patients with PD. The primary finding was an improvement in the orbit coefficient, which reflects enhanced control and coordination of wrist and elbow movements during guitar strumming. This improvement indicates that, despite the motor control challenges associated with PD, such as tremors and rigidity, guitar strumming technique can be refined and stabilized through the use of this adaptation. These results indicate that the adaptation may help PD patients engage more effectively with guitar playing by limiting involuntary movements and promoting rhythmic consistency and motion stability.

The increase in the orbit coefficient observed highlights the value of focusing on wrist movement and reducing unnecessary arm motion. Given that PD often compromises fine motor control, this adaptation could provide a way to stabilize movements, which may support patients in learning and maintaining strumming patterns more easily. As a result, individuals with PD might experience fewer barriers to learning guitar, enabling them to participate in musical activities that would otherwise be challenging. Enhancing control over strumming not only improves the immediate playing experience but may also facilitate longer-term musical learning and engagement.

The implications of improving strumming mechanics in PD patients extend beyond just the act of playing the guitar. Active music therapy, which involves patients physically playing instruments, has been shown to have beneficial effects on motor function, mood, and cognitive outcomes in individuals with PD. Guitar strumming, in particular, involves coordinated wrist and arm movements that can stimulate motor pathways and potentially reduce the impact of tremors. Moreover, engaging with music can foster a sense of achievement and motivation, promoting adherence to regular practice, which is impactful for both motor and psychological well-being. Learning an instrument such as the guitar could serve as an adjunctive therapy for PD, complementing traditional pharmacological and physical therapies. Studies have shown that playing musical instruments can enhance dopamine release, which may help mitigate some of the motor symptoms associated with dopamine depletion in PD. Additionally, rhythmic entrainment to musical cues, such as those provided by strumming a guitar, can aid in the coordination of motor activities. Thus, integrating this guitar adaptation into music therapy with a guitar may provide a non-pharmacological way to improve motor function and quality of life for patients with PD.

The potential downstream effects of learning guitar for PD patients could include not only enhanced motor control but also improvements in fine motor skills, hand dexterity, and coordination. Furthermore, by improving strumming stability, this adaptation could facilitate a more predictable and satisfying learning process, reducing frustration and maintaining patient engagement. As music therapy has been shown to positively influence mood and reduce anxiety in PD patients, learning to play guitar with the help of an adaptation can contribute to better emotional health and overall well-being.

In conclusion, a guitar adaptation can improve strumming biomechanics in individuals with PD by promoting controlled wrist movement. These findings suggest that guitar playing, with the aid of such adaptations, enhances motor function and facilitates the learning process in patients with PD.

### III. Example Method(s)

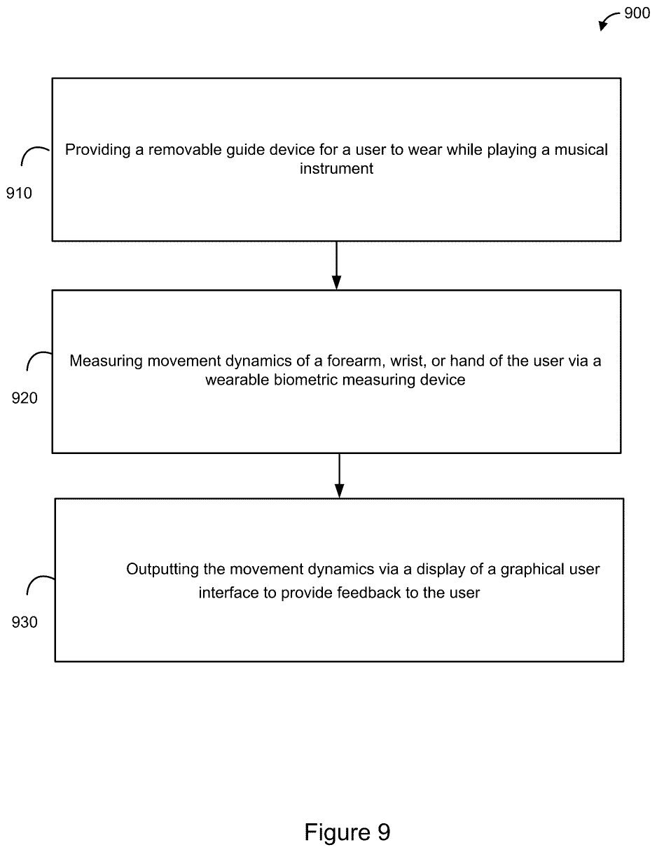

Turning to FIG. 9, FIG. 9 is a flow chart illustrating an example method 900 for improving musical instrument performance of a user.

At block 910, the method 900 can include providing a removable guide device for a user to wear while playing a musical instrument. In some examples, the musical instrument is a guitar.

At block 920, the method 900 can include measuring movement dynamics of a forearm, wrist, or hand of the user via a wearable biometric measurement device. In some examples, a biometric measurement device monitors movement by recording movement dynamics of the user including at least one of an elbow swing angle and/or a wrist swing angle. In some examples, the biometric measurement device is a wearable device including a strap to be worn on the wrist of the user. In some examples, the biometric measurement device is a watch. In some examples, the biometric measurement device comprises a camera, wherein the camera is configured to capture images or video of wrist movement of the user. In some examples, the biometric measurement device comprises at least one motion sensor configured to capture a strumming motion when the user is playing the musical instrument. In some examples, the biometric measurement device further comprises at least one of a 3-axis accelerometer or a 3-axis gyroscope. In some examples, the biometric measurement device is in wireless communication with the computing device. In some examples, the biometric measurement device comprises a rechargeable battery.

In some examples, the biometric measurement device comprises a processor and an internal memory to store the strumming motion and variations in the strumming motion. In some examples, the processor is configured to measure or calculate a plurality of parameters configured to assess strumming dynamics of the forearm, wrist, or hand of the user, wherein the plurality of parameters include a maximum elbow angle with respect to the ground, a maximum wrist angle with respect to the ground, a minimum elbow angle with respect to the ground, a minimum wrist angle with respect to the ground, and an orbit coefficient indicating a user's reliance on wrist movement and control and coordination between wrist and elbow movements to determine stability of strumming. In some examples, the biometric measurement device alerts the user with an audible sound or with a vibration, when at least one of the plurality of parameters is outside of a predetermined range.

At block 930, the method 900 can include outputting the movement dynamics via a computing device having a display (e.g., with or without a graphical user interface) to provide feedback to the user. In some examples, the computing device is in wireless communication with the biometric measurement device. Moreover, the computing device may comprise a machine learning model. In some examples, the computing device comprises a modeling computing device. In some examples, the computing device is configured to facilitate online remote learning.

### IV. Example 3

### Example of Improving Guitar Strumming Mechanics in Parkinson's Disease: A Case Series Using A Forearm Stabilization Device

### A. Introduction of Example 3

Guitar strumming is a complex motor task that entails rhythmic coordination combined with fine motor control. Achieving a balanced interplay between wrist flexibility and arm motion provides dynamic sound production, consistent strokes, and minimizes fatigue during performance. Patients with motor control impairments, such as Parkinson's disease (PD), often face challenges in executing smooth and controlled movements. The hallmark motor symptoms of PD, which include tremors, rigidity, and bradykinesia, disrupt the coordination required for effective guitar strumming, often leading to difficulties in maintaining rhythm and control. Additionally, tremors can destabilize the wrist, leading to inconsistent strumming, uncoordinated multi-planar movement (i.e., across multiple axes), and difficulty maintaining a steady rhythm.

These motor challenges can hinder the ability to produce consistent and fluid strumming and may impede the process of learning to play the guitar, which could otherwise serve as a valuable therapeutic activity. Guitar playing, when performed by patients with PD, can enhance motor coordination, reduce stress, improve rhythmicity, and provide a sense of accomplishment and creative expression.

Rhythmic Auditory Stimulation (RAS), an evidence-based technique that uses external rhythmic cues to enhance motor timing and gait in PD, has been shown to engage both cortical and subcortical networks involved in movement regulation. Adaptations that promote rhythmic entrainment through guided movement may therefore complement existing music-based interventions. However, without mechanical support, improper strumming and resulting fatigue may discourage participation, limiting access to these physical and psychological benefits.

Adaptations or adaptation devices (such as the Strum Perfect™) designed to assist those with motor control difficulties offer potential solutions for optimizing movement and enhancing performance. An adaptation device guides the forearm into a stable position while allowing greater wrist mobility. By limiting excessive multi-planar movement, this adaptation provides additional stability to the forearm, aiding patients with PD in controlling tremors, improving the consistency of their strumming motion, and supporting rhythmicity. Addressing motor challenges through assistive adaptations enables patients with PD to engage more effectively in music and occupational therapy and reap its physical and emotional benefits.

This method and example aim to explore the benefits of a guitar adaptation in enhancing the mechanics of guitar strumming among a patient sample (see Methods of Example 3). This method and study examined how the adaptation influences strumming technique and wrist stability in patients with PD, with the long-term goal of facilitating musical expression in patients with movement disorders.

### B. Methods of Example 3

### Sample

This case included a convenience sample of four patients with PD representing a range of disease stages (I-IV) and motor control abilities, with minimal prior guitar experience (i.e., either no experience or less than one year). Patients were recruited via local PD support groups. Ethical approval was obtained from an Institutional Review Board, and all patients provided informed consent prior to data collection. To maintain consistency, each participant used their own acoustic guitar or was provided with one if necessary. Patients performed standardized strumming tasks (i.e., down-strokes) at 60, 90, and 120 beats per minute (bpm) both with and without the guitar adaptation. These tempos were guided by a digital metronome, which not only provided a steady rhythm but also served as a rhythmic cue analogous to principles observed in Rhythmic Auditory Stimulation. To ensure accuracy in tempo adherence, each patient was given a brief familiarization period with the metronome at each tempo prior to data collection.

### Guitar Adaptation

The guitar adaptation (e.g., Strum Perfect™) was designed to optimize forearm positioning and increase wrist mobility during strumming. For example, the guitar adaptation may include (e.g., two) foam pads that secure the forearm against the guitar, coupled with an adjustable strap that holds the arm in place. By stabilizing the forearm, the adaptation device minimizes excessive multi-planar movement, thereby guiding the forearm's motion primarily into a single plane and encouraging proper forearm alignment while promoting greater wrist movement. Thus, the device helps to prevent excessive compensatory arm motions that may reduce efficiency and control during strumming and ensures that strumming occurs within a controlled, symmetrical range of motion, enhancing rhythmic consistency.

### Analysis of Strumming Patterns

A wrist-worn motion tracking device was used to capture strumming motion in real time. The device, equipped with a 3-axis accelerometer (±16 G) and a 3-axis gyroscope (±2000 degrees per second), provided precise motion data across multiple dimensions. Motion signals were recorded at a sampling rate of 1024 Hz on an internal memory card, ensuring high-resolution detection of subtle variations in strumming rhythm. The lightweight design (~24 grams) minimized interference with the patient's natural guitar-playing movements. Sensor fusion techniques were employed to calculate real-time angular measurements of the forearm and wrist relative to the ground. From this data, three key parameters were derived to assess strumming dynamics.

FIG. 4B illustrates the process by which motion signals are converted into angular measurements of the elbow and wrist. The first parameter, θ, represents the elbow swing angle, offering insight into elbow involvement during strumming. The second parameter, φ, captures the wrist swing angle, reflecting the dynamics of wrist movement. The final parameter, the orbit coefficient (Δφ/Δθ), quantifies the relationship between wrist twisting and elbow swinging—a higher orbit coefficient indicates greater reliance on wrist movement relative to elbow motion and suggests improved coordination.

Additionally, FIG. 4B provides a schematic of forearm and wrist motion capture during guitar strumming with the adaptation (such as the Strum Perfect™) in place. The accelerometer is placed on the dorsal forearm and oriented along the three principal axes (x, y, z) to capture multidimensional motion. The adaptation device stabilizes the forearm against the guitar body to minimize multi-planar movement. The elbow swing angle (θ) represents the arc traced by forearm rotation relative to the horizontal plane, reflecting gross arm motion. The wrist swing angle (φ) represents the angular displacement of the hand during strumming, primarily driven by wrist flexion and extension. Together, θ and φ are used to compute the orbit coefficient (Δφ/Δθ), which quantifies wrist-to-elbow movement synchrony during strumming. Higher orbit coefficient values indicate greater reliance on wrist motion and improved strumming ergonomics.

### Statistical Analyses

Descriptive statistics were calculated for the orbit coefficient with and without the adaptation. The Wilcoxon signed-rank test was used to compare the orbit coefficient at each tempo (60, 90, and 120 bpm), evaluating whether the adaptation's effect on strumming mechanics varied across different tempo conditions. Given the sample size, this non-parametric test is particularly appropriate. Analyses were conducted using Stata 17.0 software, with statistical significance set at p<0.05.

### C. Results of Example 3

All four patients had PD spanning Hoehn and Yahr stages I through IV, with a mean age of 71.8 years (SD: 8.7). There were three female patients and one male patient. Each patient had limited or no prior guitar experience (no experience: n=3; ≤1 year: n=1), allowing assessment of the adaptation's potential effects in novice guitar players with PD.

FIG. 5C depicts the relationship between wrist angle (φ, x-axis) and elbow angle (θ, y-axis) during guitar strumming for one representative participant, comparing conditions with (black traces) and without (red traces) the adaptation (Strum Perfect™). Each line represents angular motion trajectories during the strumming task. Without the adaptation, movement patterns show broader dispersion and greater variability, suggesting erratic wrist motion and increased reliance on elbow movement. In contrast, use of the adaptation produced more concentrated and constrained trajectories, reflecting improved stabilization, reduced excessive elbow motion, and greater reliance on wrist movement. These findings suggest that the adaptation helps produce smoother, more coordinated strumming patterns, and improved rhythmic precision and playability.

In short, FIG. 5C shows a relationship between elbow and wrist angles with and without the guitar adaptation in a representative patient with Parkinson's disease.

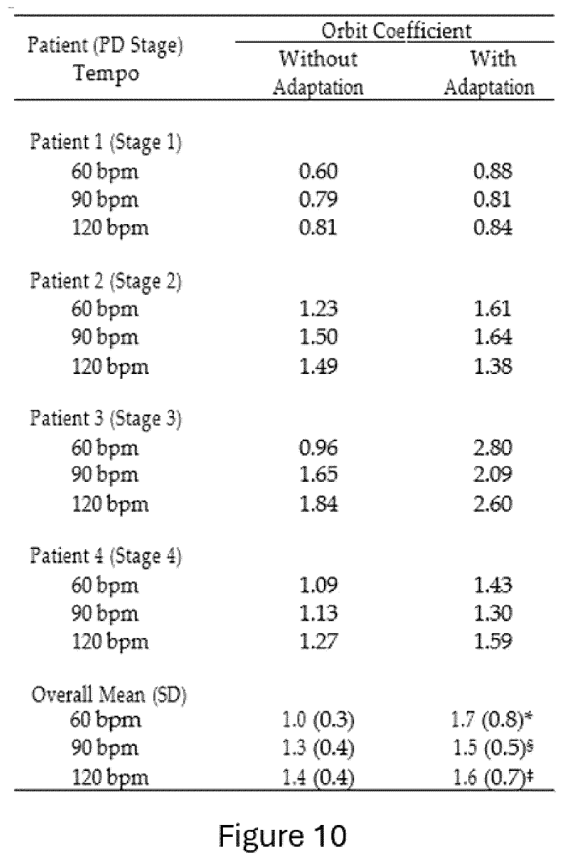

Moreover, FIG. 10 includes a table that summarizes the orbit coefficient (Δφ/Δθ), a measure of wrist-to-elbow movement synchrony, across all three tempo conditions (60, 90, and 120 bpm) for each patient with and without the adaptation. The greatest observed difference occurred at 60 bpm, where the overall mean orbit coefficient increased from 1.0 (SD: 0.3) to 1.7 (SD: 0.8) (p=0.06). Individual improvements were notable, particularly for patient 3 (increase from 0.96 to 2.80) and patient 2 (increase from 1.23 to 1.61). Both mean±SD and median values were calculated; for consistency with the table shown in FIG. 10, only means are reported here.

At 90 bpm, the orbit coefficient increased modestly from 1.3 (SD: 0.4) to 1.5 (SD: 0.5) (p=0.06), suggesting some benefit in coordination. At 120 bpm, effects were more variable, with the mean increasing from 1.4 (SD: 0.4) to 1.6 (SD: 0.7) (p=0.27). Patient 2 was the only participant whose orbit coefficient declined at this highest tempo (from 1.49 to 1.38), which may reflect fatigue or diminished coordination under faster rhythmic demands. In contrast, other patients demonstrated stable or slightly improved values.

To further contextualize the observed changes, effect sizes (Cohen's d) were calculated for the orbit coefficient: d=1.13 at 60 bpm, d=0.53 at 90 bpm, and d=0.30 at 120 bpm (e.g., supporting a large effect at slower tempos and diminishing effects at higher tempos).

### D. Discussion of Example 3

This example (e.g., case) explored the benefits of a novel device or guitar adaptation (such as the Strum Perfect™) on strumming biomechanics in patients with PD. The primary finding was an increase in the orbit coefficient, reflecting improved coordination between wrist and elbow movements during strumming. The adaptation demonstrated the most notable effects at slower tempos, where deliberate, stabilized motion may be most beneficial. At higher tempos, the effects were less consistent, possibly due to the increased motor demands and variability in individual responses. Overall, the findings suggest that the adaptation support improved wrist-to-elbow synchrony and strumming ergonomics, particularly during slower-paced playing.

The observed increase in orbit coefficient highlights the adaptation's potential to reduce erratic wrist motions and minimize excessive arm movement, which are common motor challenges in PD. Given that PD often compromises fine motor control, stabilizing the forearm and directing movement toward the wrist may help patients maintain rhythmicity and consistency while playing. These improvements reduce barriers to learning guitar and support engagement in playing music. Beyond immediate playability, enhanced strumming ergonomics may also promote longer-term musical learning and patient satisfaction.

These motor benefits demonstrate the therapeutic value of active music therapy in PD. Music therapy interventions, including rhythmic auditory stimulation and instrument-based therapy, have been shown to improve motor function, mood, and cognitive outcomes. Strumming a guitar engages coordinated upper limb movements and rhythmic entrainment, which may support motor timing and reduce tremor-related variability. Engaging with music also promotes psychological well-being and motivation, reinforcing adherence to regular practice. Prior studies have shown that music can stimulate dopamine release, potentially mitigating some of the motor symptoms associated with dopaminergic depletion. Rhythmic entrainment to musical cues has been further linked to improved movement coordination in PD. Thus, integrating this guitar adaptation into music therapy could offer a non-pharmacologic means of supporting both motor and emotional health in patients with PD.

The downstream benefits of learning guitar include enhanced motor control, improved dexterity, greater rhythmic consistency, and emotional engagement. By improving strumming stability and reducing erratic wrist motions, the adaptation may contribute to a more predictable and rewarding learning experience for individuals with PD. Given the role of music therapy in reducing anxiety and enhancing mood, the adaptation may also support psychological well-being.

In conclusion, Example 3 demonstrates that guitar adaptation improves strumming biomechanics in patients with PD by promoting controlled wrist movement. These findings suggest that guitar playing, with the aid of such adaptations, is a valuable tool for enhancing motor function and facilitating the learning process in patients with PD, along with providing a long-term impact on the motor, cognitive, and emotional health of individuals with PD.

### V. Example Variations

Although some of the acts and/or functions described in this disclosure have been described as being performed by a particular entity, the acts and/or functions can be performed by any entity. Further, although the acts and/or functions have been recited in a particular order, the acts and/or functions need not be performed in the order recited. However, in some instances, it can be desired to perform the acts and/or functions in the order recited. Further, each of the acts and/or functions can be responsive to one or more of the other acts and/or functions. Also, not all of the acts and/or functions need to be performed to achieve one or more of the benefits provided by this disclosure, and therefore not all of the acts and/or functions are required.

Although certain variations have been discussed in connection with one or more examples of this disclosure, these variations can also be applied to all of the other examples of this disclosure as well.

Although select examples of this disclosure have been described, alterations and permutations of these examples will be apparent to those of ordinary skill in the art. Other changes, substitutions, and/or alterations are also possible without departing from the invention in its broader aspects as set forth in the following claims.

Implementations of the present disclosure can thus relate to one of the enumerated examples (EE) listed below.
EE 1 is a musical instrument improvement system, the system comprising: a guide device for positioning at least one of a forearm, wrist, or hand of a user in relation to a musical instrument, the guide device including at least one strap removably coupled to the musical instrument and at least one securing portion coupled to the at least one strap to accommodate the forearm, wrist, or hand of the user; a biometric measurement device, wherein the biometric measurement device monitors movement of the forearm, wrist, or hand of the user; and a computing device comprising: one or more processors; and a graphical user interface configured to provide feedback of the position or movement of the forearm, wrist, or hand of the user, wherein the feedback is based on monitored movement received from the biometric measurement device.
EE 2 is the musical instrument improvement system of EE 1, wherein the musical instrument is a guitar.
EE 3 is the musical instrument improvement system of EE 1 or EE 2, wherein the biometric measurement device monitors movement by recording movement dynamics of the user including at least one of an elbow swing angle and a wrist swing angle.
EE 4 is the musical instrument improvement system of any of EE 1 to EE 3, wherein the biometric measurement device is a wearable device including a strap to be worn on the wrist of the user.
EE 5 is the musical instrument improvement system of any of EE 1 to EE 4, wherein the biometric measurement device is a watch.
EE 6 is the musical instrument improvement system of any of EE 1 to EE 5, wherein the biometric measurement device comprises a camera, wherein the camera is configured to capture images or video of wrist movement of the user.
EE 7 is the musical instrument improvement system of any of EE 1 to EE 6, wherein the biometric measurement device comprises at least one motion sensor configured to capture a strumming motion when the user is playing the musical instrument.
EE 8 is the musical instrument improvement system of EE 7, wherein the biometric measurement device further comprises at least one of a 3-axis accelerometer or a 3-axis gyroscope.
EE 9 is the musical instrument improvement system of EE 7, wherein the biometric measurement device further comprises a processor and an internal memory to store the strumming motion and variations in the strumming motion.
EE 10 is the musical instrument improvement system of EE 9, wherein the processor is configured to measure or calculate a plurality of parameters configured to assess strumming dynamics of the forearm, wrist, or hand of the user, wherein the plurality of parameters include a maximum elbow angle with respect to the ground, a maximum wrist angle with respect to the ground, a minimum elbow angle with respect to the ground, a minimum wrist angle with respect to the ground, and an orbit coefficient indicating a user's reliance on wrist movement and control and coordination between wrist and elbow movements to determine stability of strumming.
EE 11 is the musical instrument improvement system of EE 10, wherein the biometric measurement device alerts the user with an audible sound or with a vibration, when at least one of the plurality of parameters is outside of a predetermined range.
EE 12 is the musical instrument improvement system of any of EE 1 to EE 11, wherein the biometric measurement device is in wireless communication with the computing device.
EE 13 is the musical instrument improvement system of any of EE 1 to EE 12, wherein the biometric measurement device comprises a rechargeable battery.
EE 14 is the musical instrument improvement system of any of EE 1 to EE 13, wherein the computing device is in wireless communication with the biometric measurement device, and wherein the computing device comprises a machine learning model.
EE 15 is the musical instrument improvement system of any of EE 1 to EE 14, wherein the computing device is configured to facilitate online remote learning.
EE 16 is the musical instrument improvement system of any of EE 1 to EE 15, wherein the computing device comprises at least one of a display or a screen.
EE 17 is a method for improving musical instrument performance of a user, the method comprising: providing a removable guide device for a user to wear while playing a musical instrument; measuring movement dynamics of a forearm, wrist, or hand of the user via a wearable biometric measurement device; and outputting the movement dynamics via a display to provide feedback to the user.
EE 18 is the method of EE 17, wherein the movement dynamics of the user comprise an elbow swing angle and a wrist swing angle.
EE 19 is the method of EE 18, wherein the wearable biometric measurement device comprises a processor configured to calculate an orbit coefficient based on the elbow swing angle and the wrist swing angle.
EE 20 is a tangible, non-transitory computer readable medium comprising instructions that, when executed, cause performance of a set of operations comprising: providing a removable guide device for a user to wear while playing a musical instrument; measuring movement dynamics of a forearm, wrist, or hand of the user via a wearable biometric measurement device; and outputting the movement dynamics via a display to provide feedback to the user.

What is claimed is:

1. A musical instrument improvement system, the system comprising:
a guide device for positioning at least one of a forearm, wrist, or hand of a user in relation to a musical instrument, the guide device including at least one strap removably coupled to the musical instrument and at least one securing portion coupled to the at least one strap to accommodate the forearm, wrist, or hand of the user;
a biometric measurement device, wherein the biometric measurement device monitors movement of the forearm, wrist, or hand of the user; and
a computing device comprising:
one or more processors; and
a graphical user interface configured to provide feedback of the position or movement of the forearm, wrist, or hand of the user, wherein the feedback is based on monitored movement received from the biometric measurement device.

2. The musical instrument improvement system of claim 1, wherein the musical instrument is a guitar.

3. The musical instrument improvement system of claim 1, wherein the biometric measurement device monitors movement by recording movement dynamics of the user including at least one of an elbow swing angle and a wrist swing angle.

4. The musical instrument improvement system of claim 1, wherein the biometric measurement device is a wearable device including a strap to be worn on the wrist of the user.

5. The musical instrument improvement system of claim 1, wherein the biometric measurement device is a watch.

6. The musical instrument improvement system of claim 1, wherein the biometric measurement device comprises a camera, wherein the camera is configured to capture images or video of wrist movement of the user.

7. The musical instrument improvement system of claim 1, wherein the biometric measurement device comprises at least one motion sensor configured to capture a strumming motion when the user is playing the musical instrument.

8. The musical instrument improvement system of claim 7, wherein the biometric measurement device further comprises at least one of a 3-axis accelerometer or a 3-axis gyroscope.

9. The musical instrument improvement system of claim 7, wherein the biometric measurement device further comprises a processor and an internal memory to store the strumming motion and variations in the strumming motion.

10. The musical instrument improvement system of claim 9, wherein the processor is configured to measure or calculate a plurality of parameters configured to assess strumming dynamics of the forearm, wrist, or hand of the user, wherein the plurality of parameters include a maximum elbow angle with respect to the ground, a maximum wrist angle with respect to the ground, a minimum elbow angle with respect to the ground, a minimum wrist angle with respect to the ground, and an orbit coefficient indicating a user's reliance on wrist movement and control and coordination between wrist and elbow movements to determine stability of strumming.

11. The musical instrument improvement system of claim 10, wherein the biometric measurement device alerts the user with an audible sound or with a vibration, when at least one of the plurality of parameters is outside of a predetermined range.

12. The musical instrument improvement system of claim 1, wherein the biometric measurement device is in wireless communication with the computing device.

13. The musical instrument improvement system of claim 1, wherein the biometric measurement device comprises a rechargeable battery.

14. The musical instrument improvement system of claim 1, wherein the computing device is in wireless communication with the biometric measurement device, and wherein the computing device comprises a machine learning model.

15. The musical instrument improvement system of claim 1, wherein the computing device is configured to facilitate online remote learning.

16. The musical instrument improvement system of claim 1, wherein the computing device comprises at least one of a display or a screen.

17. A method for improving musical instrument performance of a user, the method comprising:
providing a removable guide device for a user to wear while playing a musical instrument;
measuring movement dynamics of a forearm, wrist, or hand of the user via a wearable biometric measurement device; and
outputting the movement dynamics via a display to provide feedback to the user.

18. The method of claim 17, wherein the movement dynamics of the user comprise an elbow swing angle and a wrist swing angle.

19. The method of claim 18, wherein the wearable biometric measurement device comprises a processor configured to calculate an orbit coefficient based on the elbow swing angle and the wrist swing angle.

20. A tangible, non-transitory computer readable medium comprising instructions that, when executed, cause performance of a set of operations comprising:
providing a removable guide device for a user to wear while playing a musical instrument;
measuring movement dynamics of a forearm, wrist, or hand of the user via a wearable biometric measurement device; and
outputting the movement dynamics via a display to provide feedback to the user.
